(19) United States
(12) Patent Application Publication
(10) Pub. No.: US 2014/0084507 A1
(43) Pub. Date: Mar. 27, 2014

(54) Multi Chamber Apparatus and Method for Forming Carbon Dioxide Particles Into Blocks

(71) Applicant: COLD JET LLC, Loveland, OH (US)

(72) Inventors: Frederick Charles Young, Maineville, OH (US); Scott Thomas Hardoerfer, Milford, OH (US)

(73) Assignee: COLD JET LLC, Loveland, OH (US)

(21) Appl. No.: 13/624,776

(22) Filed: Sep. 21, 2012

(51) Int. Cl. B29C 43/34; B28B 13/02

(52) U.S. Cl. 264/109; 425/344

(57) ABSTRACT

An apparatus for forming one or more blocks from carbon dioxide particle is configured to allow changing between precise thicknesses with very little downtime, utilizing both weight based and volumetric dosing. A spacer supports the lower ejection piston during block forming, with a shuttle discharging particles into the forming chamber while simultaneously pushing one or more previously formed blocks on to a conveyor. In one embodiment, the shuttle dosing cavity has a volume that is greater than the volume of the forming chamber volume, which allows more pellets, volumetrically, to be dosed into the dosing cavity than the volume of the forming cavity.

### BACKGROUND OF THE INVENTION

The present invention relates to forming solid blocks of a cryogenic material, and is particularly directed to a method and multi chamber apparatus for forming carbon dioxide particles into blocks.

Carbon dioxide has many uses in its various phases. Solid carbon dioxide has long been used to maintain items, such as food or beverages at desirable cool temperatures. In certain food service applications, solid blocks, or cakes, of carbon dioxide have been used, disposed within a given volume adjacent the items sought to be maintained at or below a desired temperature.

The airline industry is an example of this use of carbon dioxide blocks, wherein carbon dioxide blocks of a preselected size are disposed within one or more compartments of the food carts, thereby keeping the food served to air passengers at or below the desired temperature. In order to meet such need for carbon dioxide blocks, it is known to cut carbon dioxide blocks of the desired size from larger blocks as well as to form the desired sized blocks from carbon dioxide particles. There is a need for flexibility to be able to provide different sized blocks matched to the specific compartment sizes.

The present invention provides a method and apparatus device for forming particles into blocks which produces accurately sized blocks and which allows the size of the blocks to be changed with minimal down time. Although the present invention will be described herein in connection with carbon dioxide, it will be understood that the present invention is not limited in use or application to carbon dioxide.

### BRIEF DESCRIPTION OF THE DRAWINGS

The accompanying drawings, which are incorporated in and constitute a part of this specification, illustrate embodiments of the invention, and, together with the general description of the invention given above, and the detailed description of the embodiments given below, serve to explain the principles of the present invention.

FIG. 1 is a perspective view of a block former constructed in accordance with teachings of the present invention.

FIG. 2 is a perspective view of the block former of FIG. 2 with certain components omitted for clarity.

FIG. 3 is a side cross-sectional perspective view of the block former of FIG. 2 taken along the midline of one of the forming lines.

FIG. 4 is perspective view of components of the vibrating tray assembly of the former of FIG. 1.

FIG. 5 is a perspective view of an alternate embodiment of the vibrating tray.

FIG. 6 is a perspective view of the left dosing shuttle and forming assembly of the former of FIG. 1.

FIG. 7 is a side cross-sectional bottom perspective view of the dosing shuttle and forming assembly shown in FIG. 6. taken along the midline of the dosing shuttle and forming assembly.

FIG. 8 is a side perspective view of the forming assembly of FIG. 6, with an alternate embodiment of the weighing structure and the dosing shuttle omitted for clarity.

FIG. 9 is a side perspective view showing the dosing shuttle assembly with the dosing shuttle hydraulic omitted for clarity.

FIG. 10 is a side perspective view similar to FIG. 9 with a shuttle guide and a lower plate omitted for clarity.

FIG. 11 is a bottom side perspective view of the dosing shuttle assembly shown in FIG. 10.

FIG. 12 is a side perspective view similar to FIG. 10 with the weighing plate omitted for clarity.

FIG. 12A is a bottom side perspective view of an alternative embodiment of a load cell for use with the dosing shuttle assembly of FIG. 9.

FIG. 13 is a cross-sectional top perspective view of the dosing shuttle and forming assembly similar to FIG. 7.

FIGS. 14 and 14A are side perspective views of the dosing shuttle and forming assembly of FIG. 6, with the front block pivoted to the open position.

FIG. 15 is a front perspective view of the dosing shuttle and forming assembly of FIG. 6 with the ejection piston and spacer exploded out.

FIGS. 16 is a front perspective view of the dosing shuttle and forming assembly of FIG. 6, with the spacer oriented for insertion into the forming assembly.

FIG. 17 is a front perspective view similar to FIG. 16, illustrating the spacer being installed under the ejection piston.

FIG. 18 is a side view of the dosing shuttle and forming assembly of FIG. 6, showing the spacer tilted during installation.

FIG. 19 is a side view of the dosing shuttle and forming assembly of FIG. 6 similar to FIG. 18, showing the spacer installed under the ejection piston.

FIG. 20 is an enlarged bottom perspective view of the spacer.

FIG. 21 is a front perspective view similar to FIG. 17, with the spacer installed under the ejection piston, showing the press piston assembly and press piston guide exploded out.

FIG. 22 is a front perspective view similar to FIG. 21, showing the press guide installed.

FIG. 23 is a front perspective view similar to FIG. 21, showing the press piston assembly and press piston guide installed.

FIG. 24 is a front perspective view of the dosing shuttle and forming assembly, similar to FIGS. 14 and 14A, illustrating a step in the removal process of the forming chamber block and ejection piston.

FIG. 25 is a front perspective view similar to FIG. 24, illustrating the forming chamber block and ejection piston removed (and with the press piston omitted).

FIG. 26 is side perspective view of the forming chamber block with one side omitted for clarity.

FIGS. 27-31 are side cross-sectional drawings illustrating the process of forming a block.

FIG. 32 is a side cross-sectional view of the volumetric shuttle shown in FIGS. 27-31.

FIG. 33 is a perspective view of the conveyor assembly shown in FIG. 1.

FIG. 34 is a perspective view of the conveyor belt assembly.

FIG. 35 is an enlarged fragmentary view of the conveyor belt engaged by a drive sprocket.

FIG. 36 is a perspective view of an alternative embodiment of a forming chamber block and upper and lower piston assemblies to form a forming chamber block and dual piston assembly for use with the dosing shuttle and forming assembly of FIG. 6.

FIG. 37 is cross-sectional view of the forming chamber block and dual piston assembly of FIG. 36 taken along line 37-37.

FIG. 38 is a partial cross-sectional view of the forming chamber block and dual piston assembly of FIG. 37 in which the upper and lower piston assemblies are removed from the forming chamber block.

FIG. 39 is a perspective view in partial cross-section of the forming chamber and dual piston block assembly of FIG. 36 taken along a midline aligned with line 37-37.

FIG. 40 is a perspective view of the forming chamber block and dual piston assembly of FIG. 36 in which the upper and lower piston assemblies are removed from the forming chamber block.

FIG. 41 is an exploded perspective view of the forming block of FIG. 40.

FIG. 42 is a perspective view showing the press piston assembly assembled to the forming assembly shown in FIG. 6 including a leg configured to receive a press piston guide exploded out.

FIG. 43 is a perspective view of an alternative embodiment of a forming chamber block and upper and lower piston assemblies to form a forming chamber block and dual piston assembly for use with the dosing shuttle and forming assembly of FIG. 6 in which the upper and lower piston assemblies are removed from the forming chamber block.

Reference will now be made in detail to the present preferred embodiment of the invention, an example of which is illustrated in the accompanying drawings.

### DETAILED DESCRIPTION OF AN EMBODIMENT OF THE INVENTION

In the following description, like reference characters designate like or corresponding parts throughout the several views. Also, in the following description, it is to be understood that terms such as front, back, inside, outside, and the like are words of convenience and are not to be construed as limiting terms. Terminology used in this patent is not meant to be limiting insofar as devices described herein, or portions thereof, may be attached or utilized in other orientations. Referring in more detail to the drawings, an embodiment of the invention will now be described.

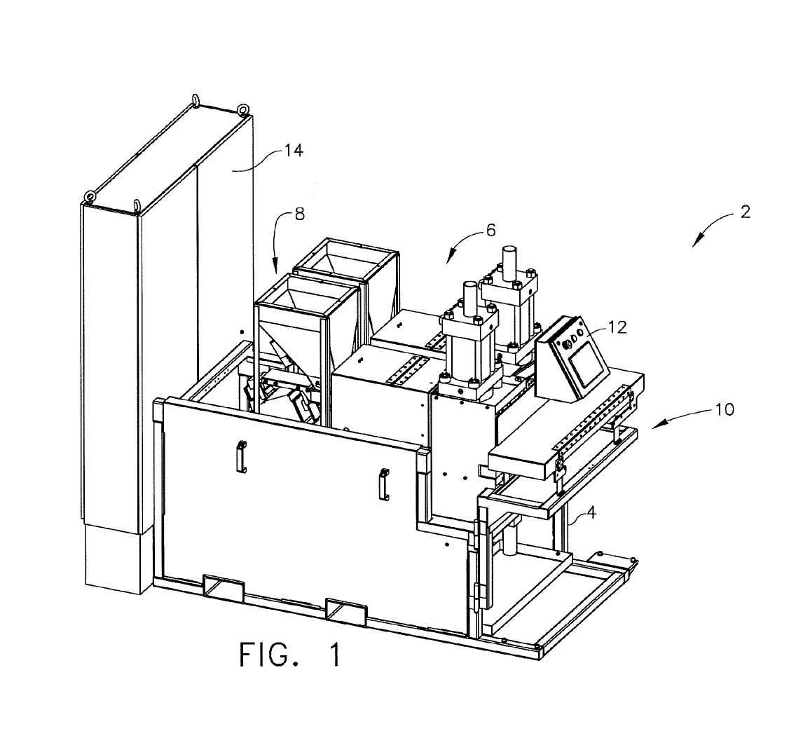

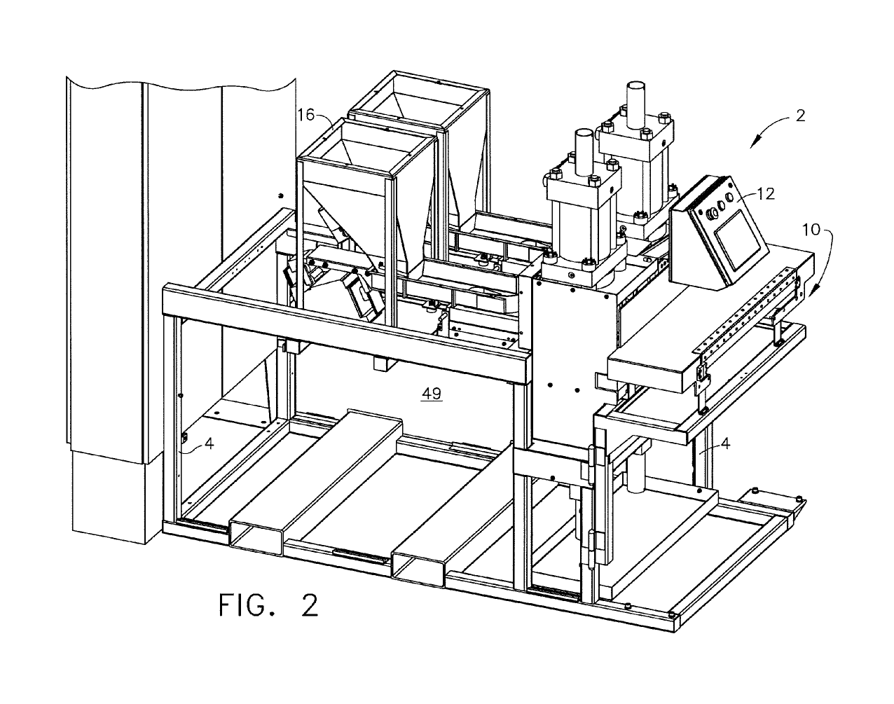

Referring to FIGS. 1 and 2, there is shown an apparatus, indicated generally at 2 for forming carbon dioxide blocks, also referred to herein as a former or reformer. Former 2 includes frame 4 which supports the former's components and includes an enclosure (not completely shown). Former 2 includes two forming lines, generally indicated at 6 and 8, although former 2 may have one or more than two forming lines. Former 2 includes conveyor assembly 10, human machine interface (HMI) 12 and enclosure 14 for housing power and control components. Not illustrated is the hydraulic fluid supply system which provides a source of pressurized hydraulic fluid, preferably food grade, for the hydraulic cylinders of the former 2. The hydraulic fluid source may be carried by frame 4, such as in a space defined by frame 4, or mounted remote to former 2.

Although the size of the components of both forming lines 6 and 8 may differ, the component functions and processes of each line are the same. Thus, only line 8 will be discussed herein in detail.

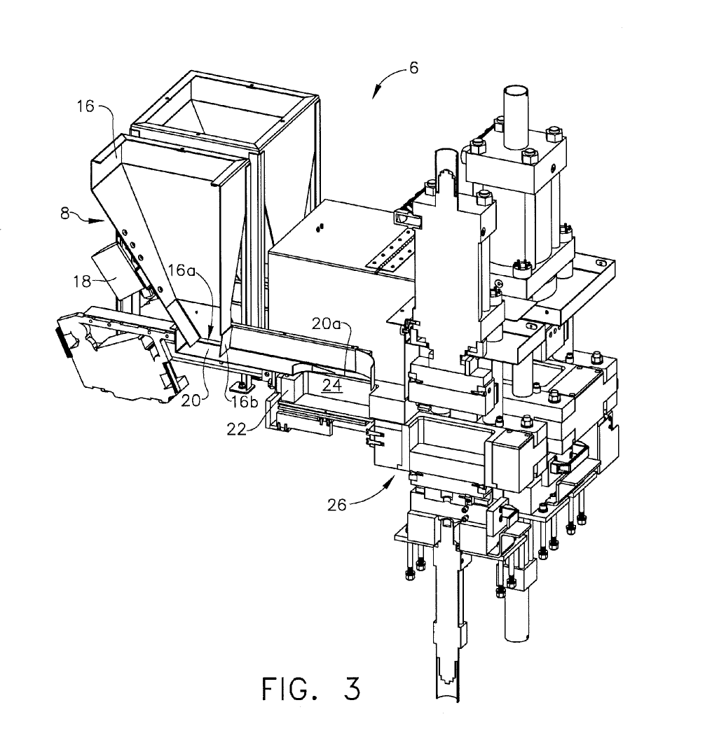

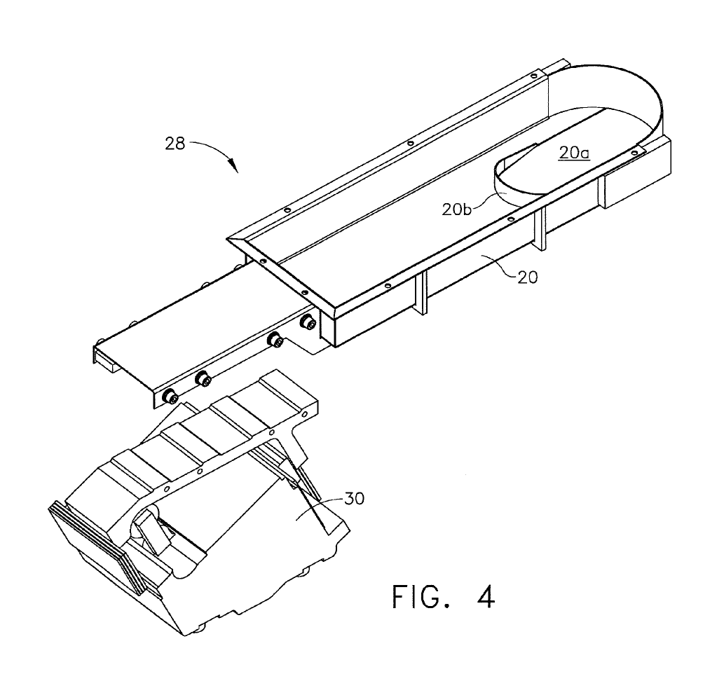

Referring also to FIG. 3, forming line 8 includes hopper 16 configured to receive particles, in this embodiment, carbon dioxide particles. In one embodiment, the lengths of the particles are less than about 0.5 inches. Vibrator 18 is carried by hopper 16. Any suitable device promote the flow of particles downwardly toward and out exit 16a of hopper 16 may be used. Exit 16a overlies dispensing tray 20, and includes door 16b to control the flow of particles from hopper 16 to tray 20. Dispensing tray 20 includes opening 20a (see also FIG. 4) which overlies dosing shuttle 22 and dosing cavity 24, with a small gap therebetween, about 0.5 to 1 inch.

Forming line 8 also includes forming assembly 26, which will be discussed in more detail below.

Referring to FIG. 4, dispensing assembly 28 is illustrated as comprising dispensing tray 20 which is mounted to vibrator 30 (FIG. 4 illustrated tray 20 exploded from vibrator 30). Vibrator 30 is carried by frame 4, and functions to vibrate tray 20 so as to advance particles toward opening 20a. Vibrator 30 may be any of any suitable construction, such as may be well known. In the embodiment depicted, vibrator 30 was manufactured by Eriez. Tray 20 includes diverter 20b configured to direct particles there around so as to be introduced into dosing cavity 24 from the sides of opening 20a, to promote uniform distribution of particles in dosing cavity 24.

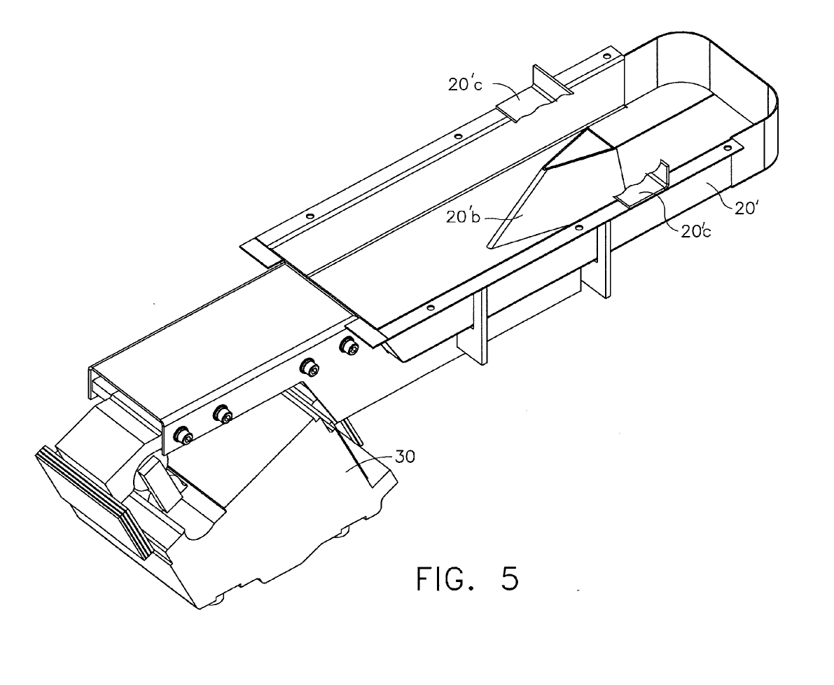

FIG. 5 is a perspective view of an alternate vibrating tray embodiment, identified as 20′, having a different shaped diverter 20′b. FIG. 5 illustrates a fragmentary support bracket 20′c for structural support to tray 20′.

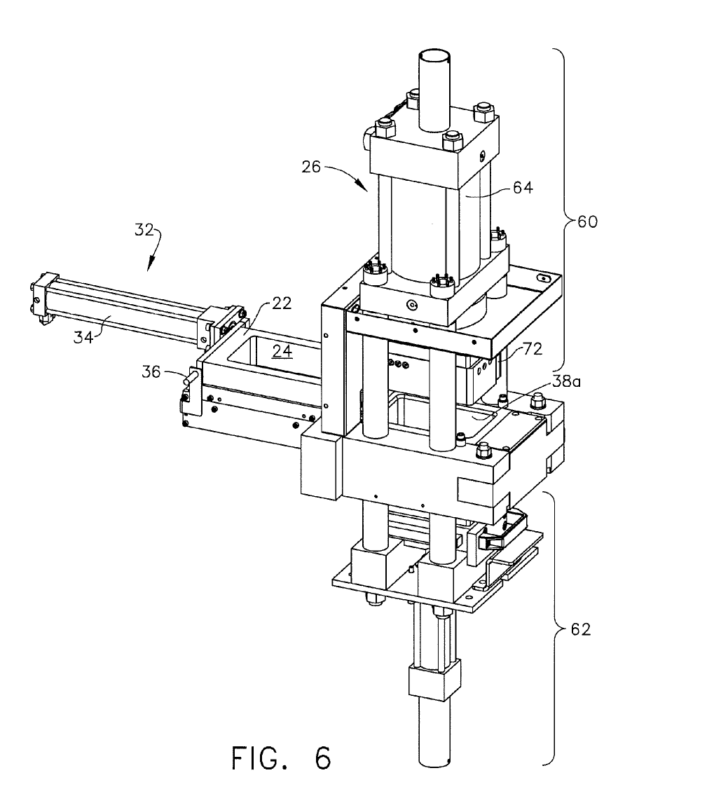

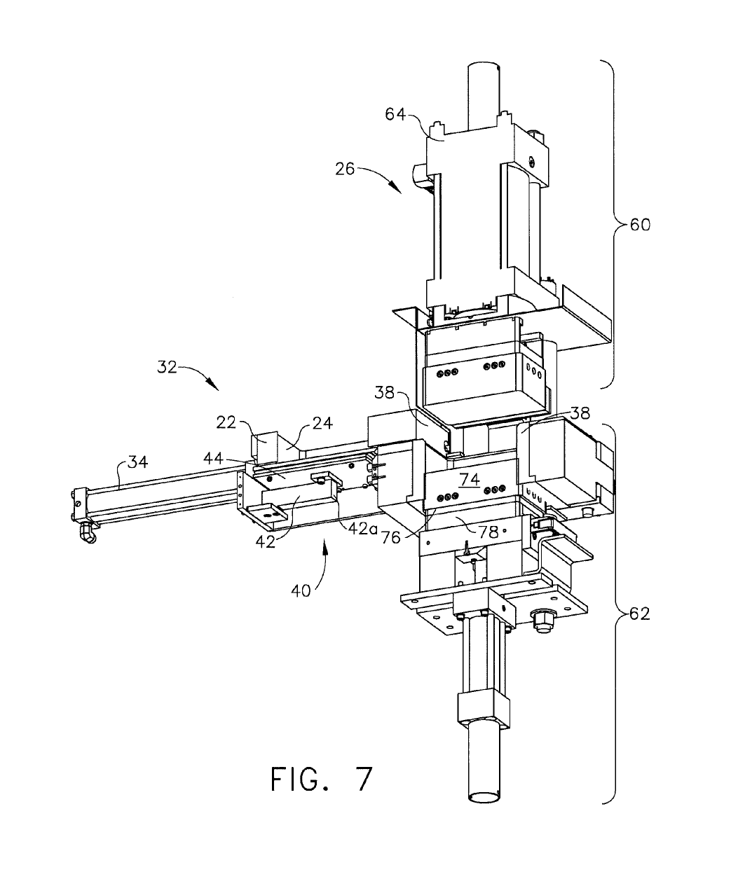

Referring to FIGS. 6 and 7, dosing assembly 32 and forming assembly 26 of forming line 8 are shown. Dosing assembly 32 includes hydraulic cylinder 34 for reciprocating dosing shuttle 22 from a first position at which dosing cavity 24 is aligned with opening 20a so that dosing cavity 24 can be charged with particles, and a second position at which dosing cavity 24 is aligned with forming chamber 38a so that forming chamber 38a can be charged with particles discharged from dosing cavity 24, and a third position at which dosing shuttle 22 has pushed one or more formed blocks onto the conveyor. Sensor 36 is positioned to sense when dosing shuttle 22 is in the charging position, and another sensor (not seen in FIG. 6) senses when dosing cavity 24 is aligned with forming chamber 38a. Dosing shuttle 22 may be made of any suitable material, such as UHMW.

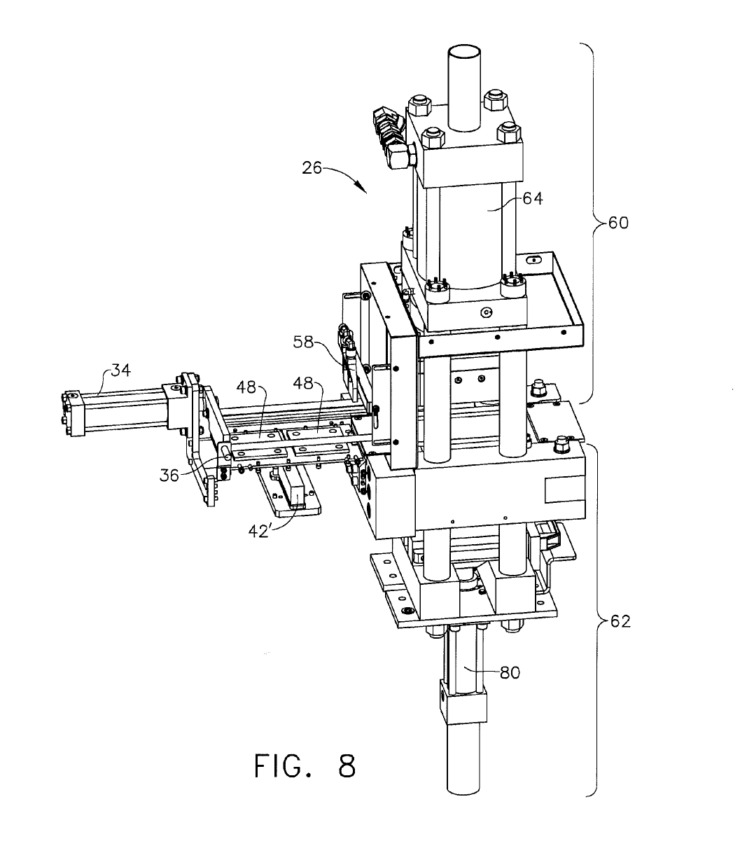

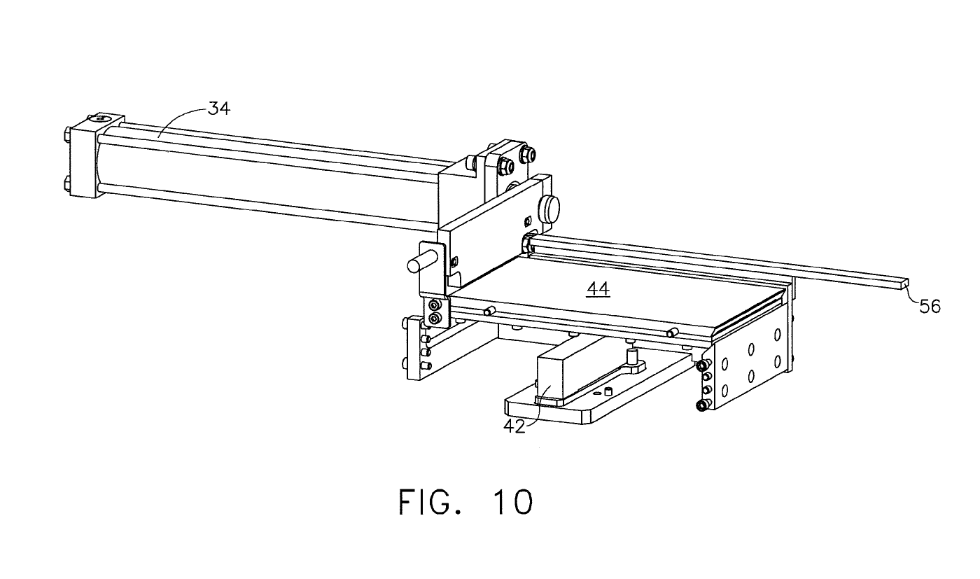

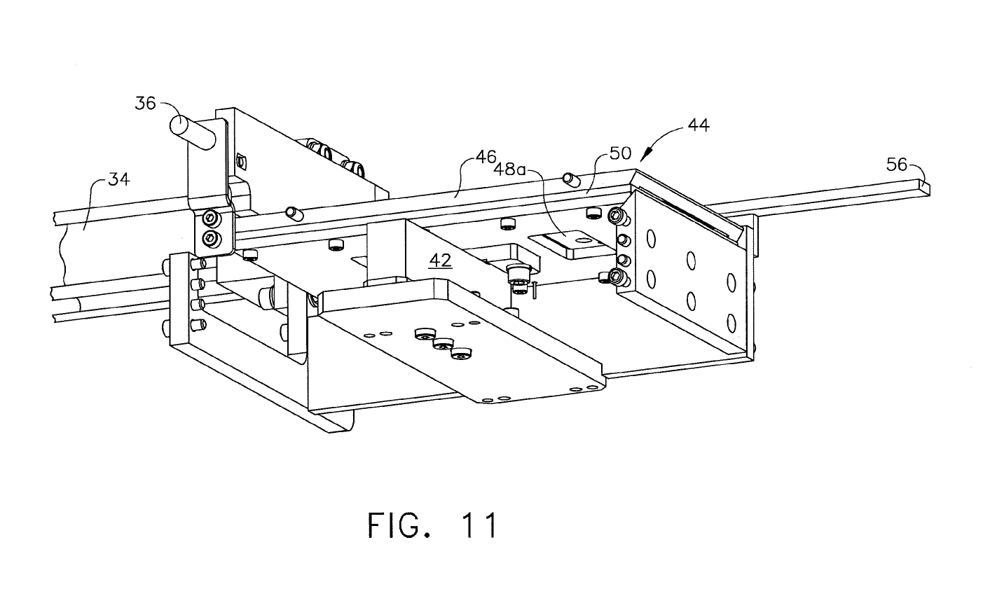

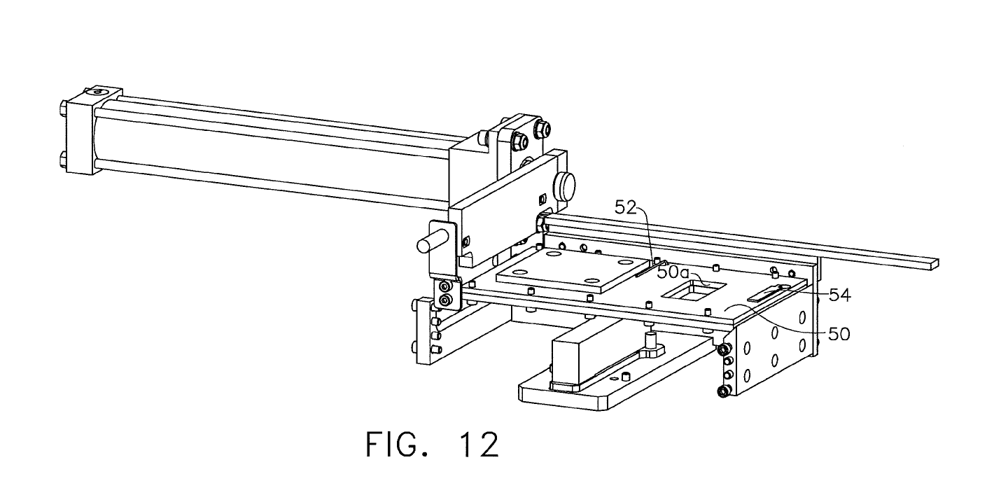

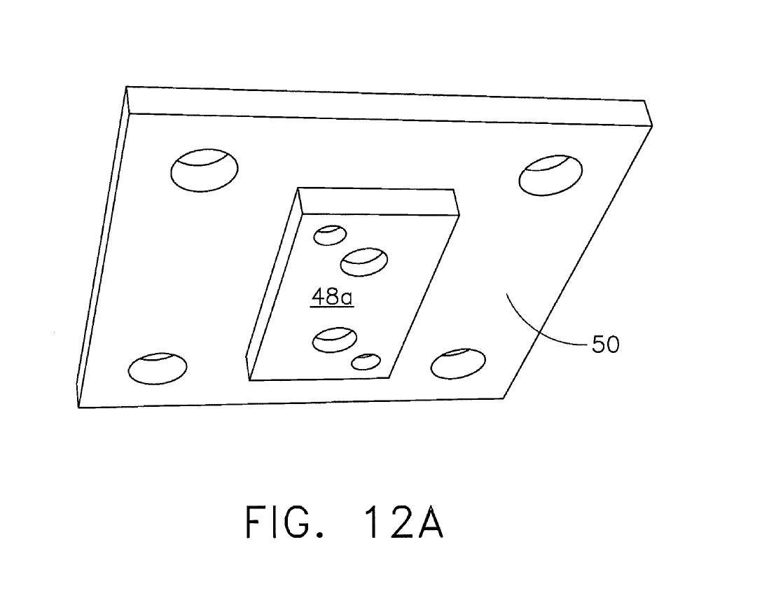

In this embodiment depicted, the amount particles dispensed into dosing cavity 24 is determined by the weight of the particles within dosing cavity 24. In FIG. 7, weighing system 40 can be seen comprising load cell 42 cantilevered at one end, and supporting and locating weighing platform 44 at distal end 42a. Referring also to FIGS. 8-12a, which depict an alternate embodiment of load cell 42′, cantilevered from the lateral side instead of the longitudinal side, weighing platform 44 includes upper plate 46 made of stainless steel in the depicted embodiment. The lower surface of upper plate 46 includes cavities (not shown) into which a pair of heaters 48 extend. Each heater includes a downwardly depending projection 48a (FIG. 12a) that extending into openings 50a formed in intermediate plate 50 of weighing platform 44. Thermocouple 52 is embedded in the bottom surface of upper plate 46. Ceramic heater 54 is also disposed adjacent or embedded into the lower surface of upper plate 46, disposed to prevent particles from freezing at that end of the weighing platform (it being noted that shuttle 22 moves relative to weighing platform 44. A pair of air knives 58 (FIG. 8) are disposed at the end of dosing assembly 32 adjacent the forming assembly 26, which are connected to a source of pressurized air, such as shop air, to reduce the chance of agglomerating particles at that location.

When the signal from load cell 42 indicates the desired weight of particles are present within dosing cavity 42, the system controller stops the flow of particles into dosing cavity 42 by stopping the vibration of dispensing tray 20. When the desired weight of particles are present, the shuttle is controlled to charge forming chamber 38a.

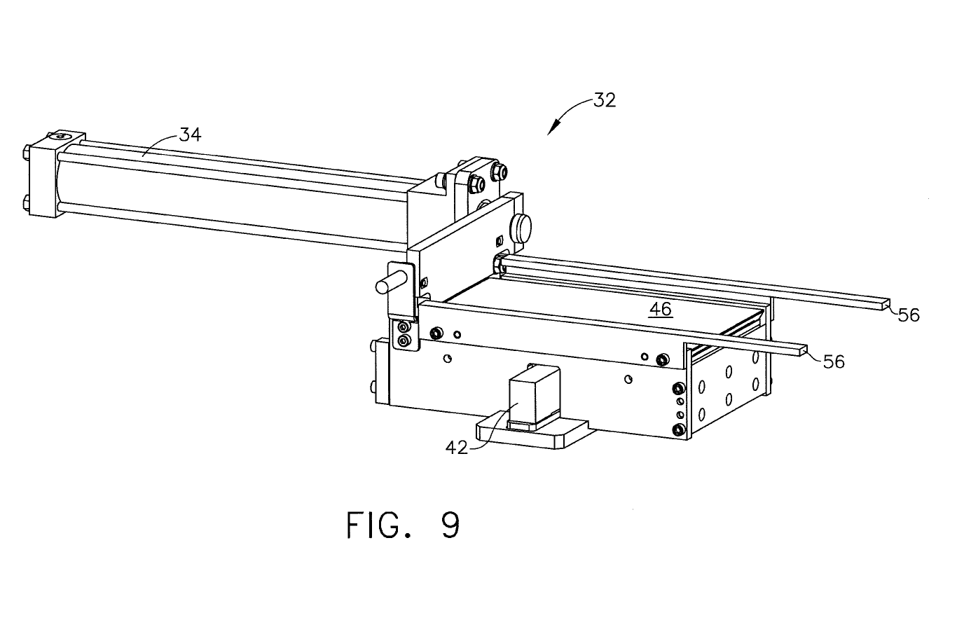

As seen in FIG. 9, a pair of spaced apart guide rails 56 are supported by the dosing assembly. Guide rails 56 guide dosing shuttle 22 so as to maintain the appropriate position relative to the other components. In the embodiment depicted, guide rails 56 are illustrated as having a combined rectangular and T cross section. Guide rails 56 may be of any suitable cross sectional shape and length so as to maintain dosing shuttle 22 in the appropriate position relative to the other components.

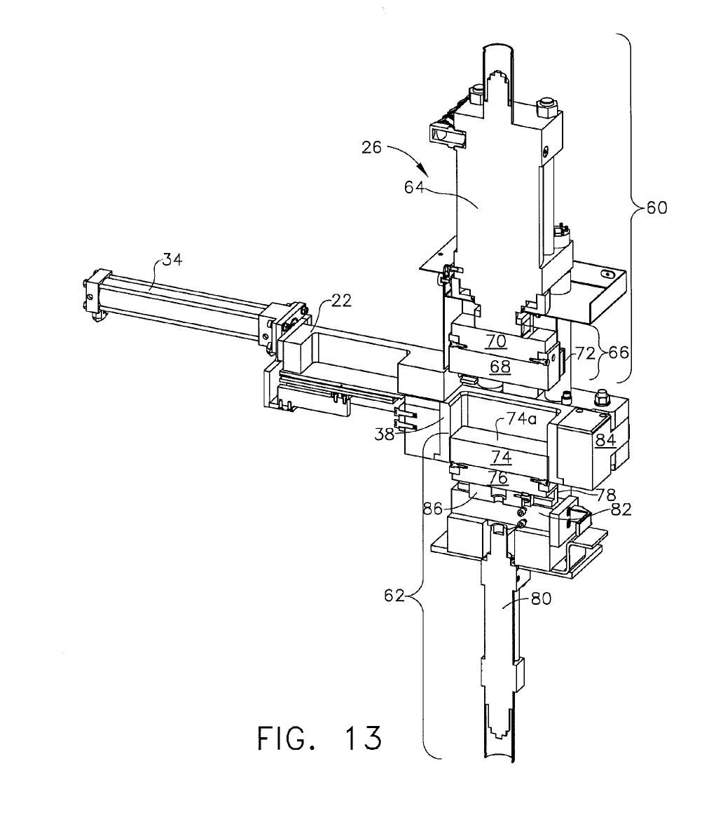

Included in FIGS. 6, 8 and 13 are illustrations of forming assembly 26. Forming assembly 26 includes piston assembly 60, forming chamber block 38 and eject assembly 62. Piston assembly 60 includes press hydraulic cylinder 64 and press piston assembly 66 attached thereto. Press piston assembly includes press piston 68 which is attached to press piston block 70, both of which are disposed in the retracted position high enough to allow dosing shuttle 22 to travel between its first position and its second and third positions (described above). Press piston 68 may be made of any suitable material, such as UHMW. As can be seen in the cross-section of FIG. 13, the lower relieved portion of press piston block 70 extends into a recess formed in the upper surface of press piston 68 such that the two components are secured together by fasteners.

The orientation and location of press piston 68 is maintained by press piston guide 72. Press piston 68 is maintained in alignment with forming chamber 38a. The upper edges of forming chamber 38a are chamfered to provide a lead in for press piston 68 so that it can enter forming chamber 38a without interfering with the upper edges of forming chamber 38a, and proceed to compress carbon dioxide particles into blocks, as described below. Adequate clearance between press piston 66 and the walls of forming chamber 38a is provided, which in the embodiment depicted is about 0.020 to 0.030 inches on a side.

Eject assembly 62 includes eject piston 74, formed of any suitable material such as UHMW and which is attached to eject piston block 76 in the same manner as press piston 68 and press piston block 70. Eject piston block 76 is mounted to eject piston mounting slide 78 which is releasably connected to eject hydraulic cylinder 80. Spacer 82 is disposed beneath eject piston mounting slide 78, supported vertically on its lower side, establishing the position of the upper surface 74a of eject piston 74 within forming chamber 38a. During formation of blocks, as described below, spacer 82 functions as the reaction member to the force exerted by press piston 68, through the carbon dioxide particles, through eject piston 74, and through eject piston block 76. With this construction, lower eject hydraulic cylinder 80 is not sized to oppose the force of press hydraulic cylinder 64, but only sized to lift eject piston 74 to eject a formed block.

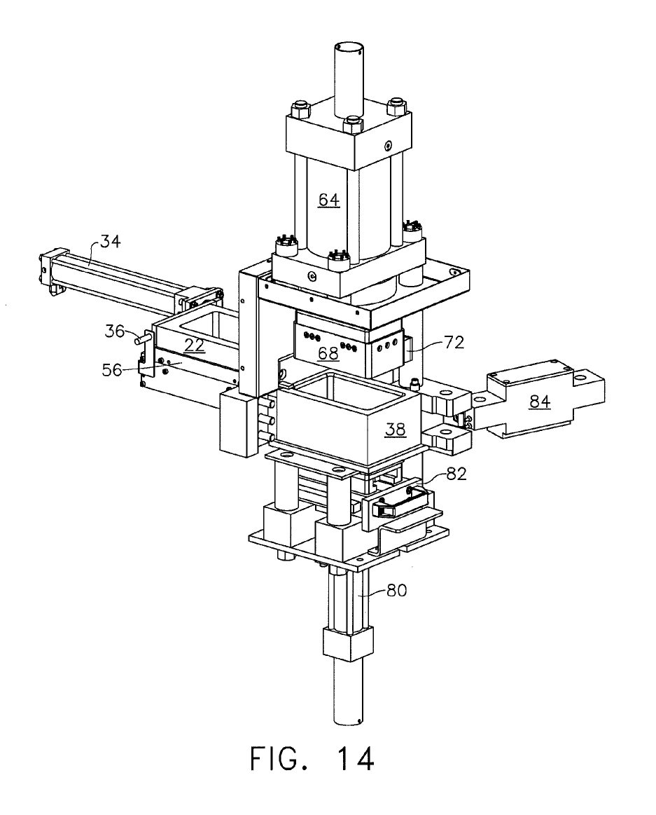

FIGS. 14 and 14A illustrate front block 84 pivoted to its open position, allowing access to forming block 38 for removal, such as to exchange for another size block. Forming block 38 may be of any suitable dimension, such as 210 cm×125 cm or 150 cm×150 cm. The removal and installation of forming block 38 is described below.

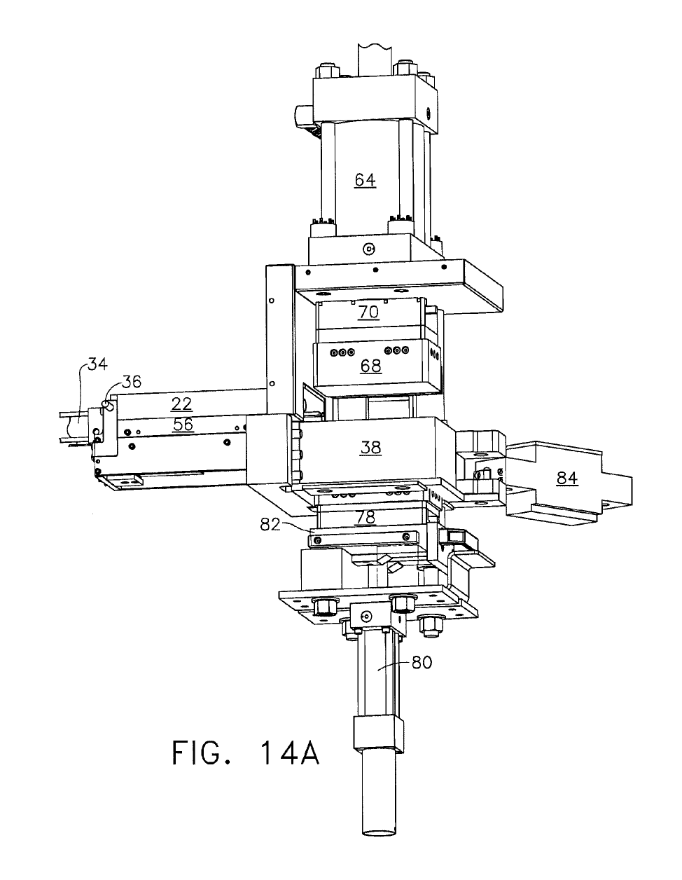

Referring to FIG. 15, eject piston 74 and spacer 82 are illustrated removed from eject assembly 62. As seen in FIG. 15, the upper end of eject hydraulic cylinder 80 carries mount 86 which is configured to slidably receive eject piston mounting slide 78. It is noted that the process for removing eject piston 74, as described below, involves locating eject piston 74 within forming chamber 38a and removing forming block 38 while eject piston 74 is disposed therein.

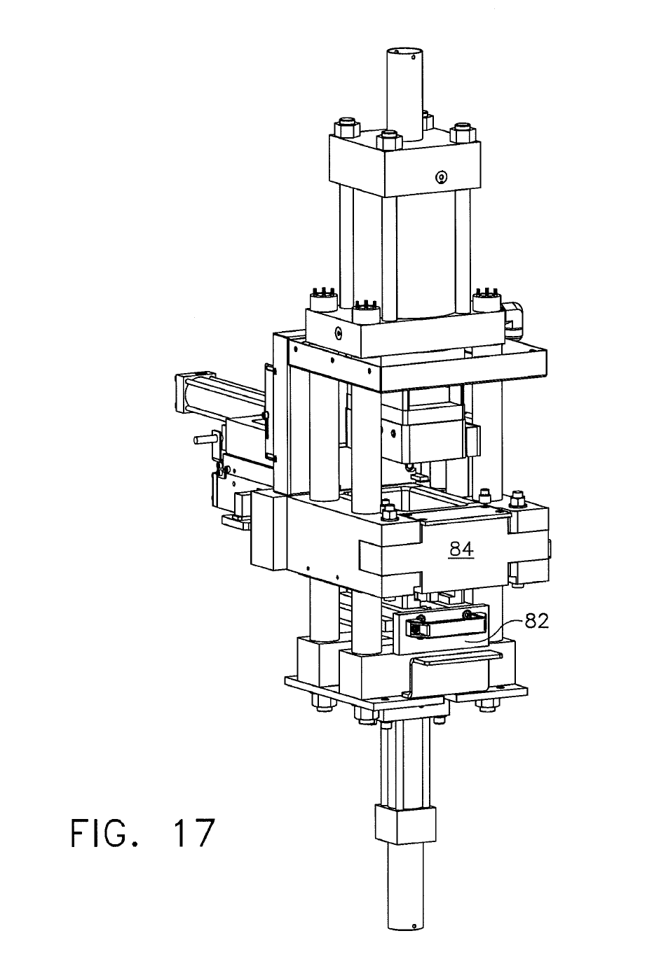

FIGS. 15-19 illustrate the process for installing spacer 82. The thickness of spacer 82 sets the location of upper surface 74a of eject piston 74, which may be used, at least in certain embodiments, to control the volume of particle disposed into forming chamber 38a, such as when forming chamber 38a is filled completely to its upper edge, thereby controlling the thickness of the formed block. Of course, as described above, when a metered dose is dispensed into dosing chamber 24, such as based on weight, forming chamber does not have to be filled to its upper edge to produce the desired thickness of the formed block.

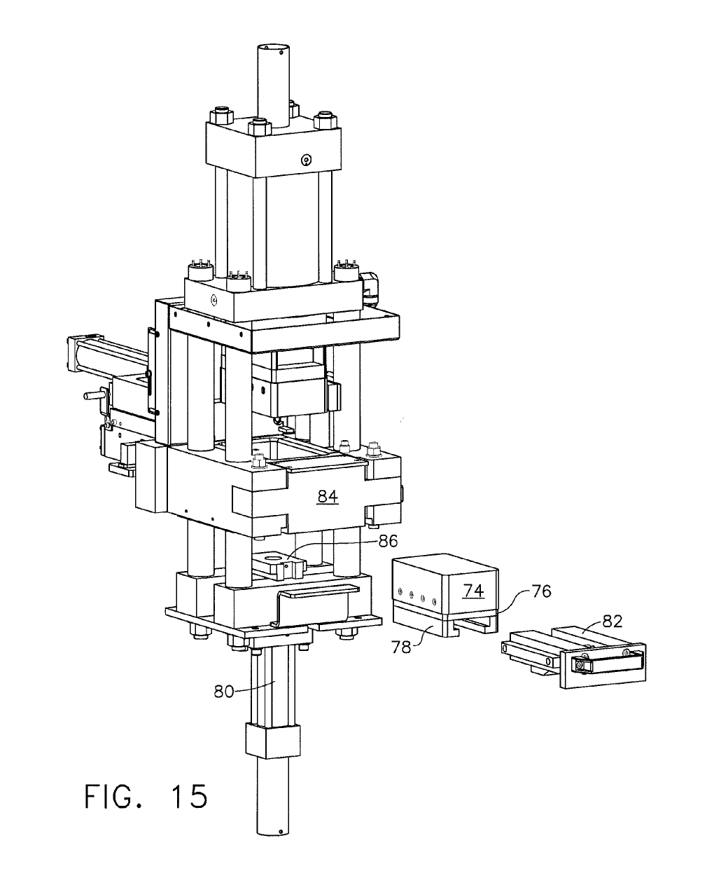

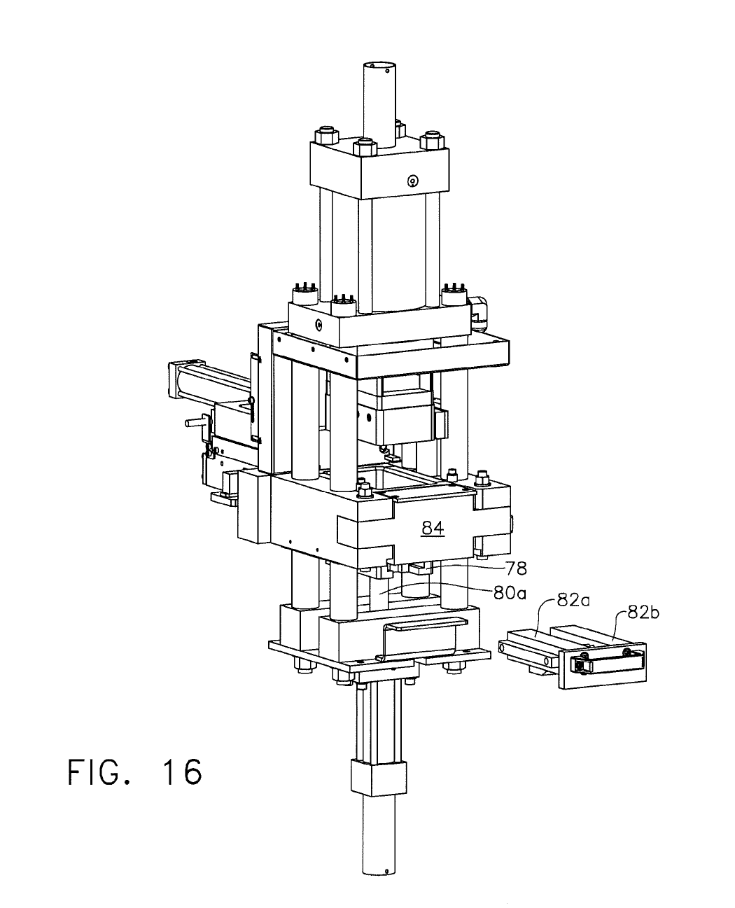

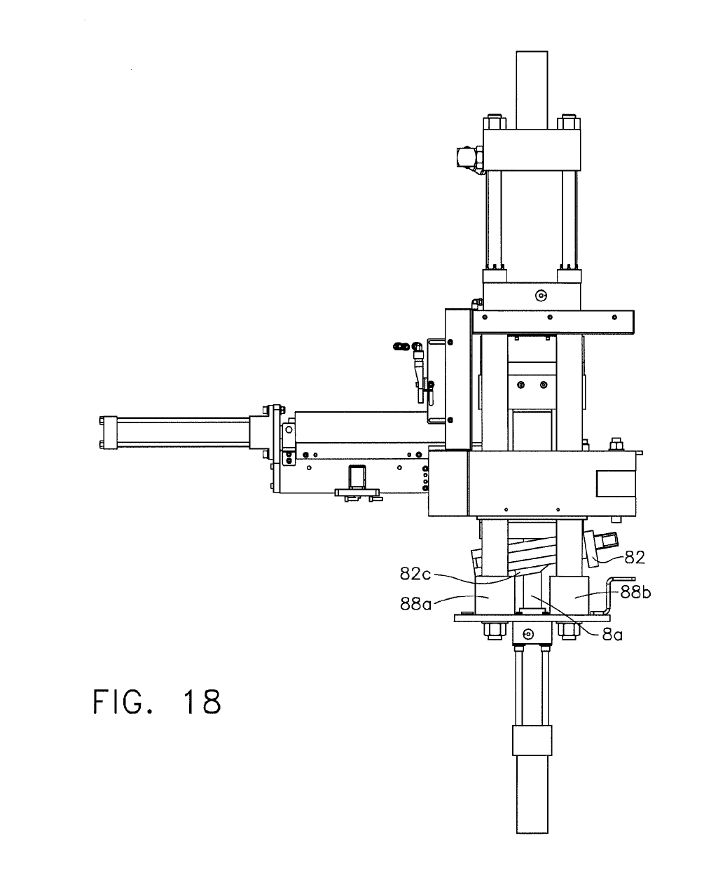

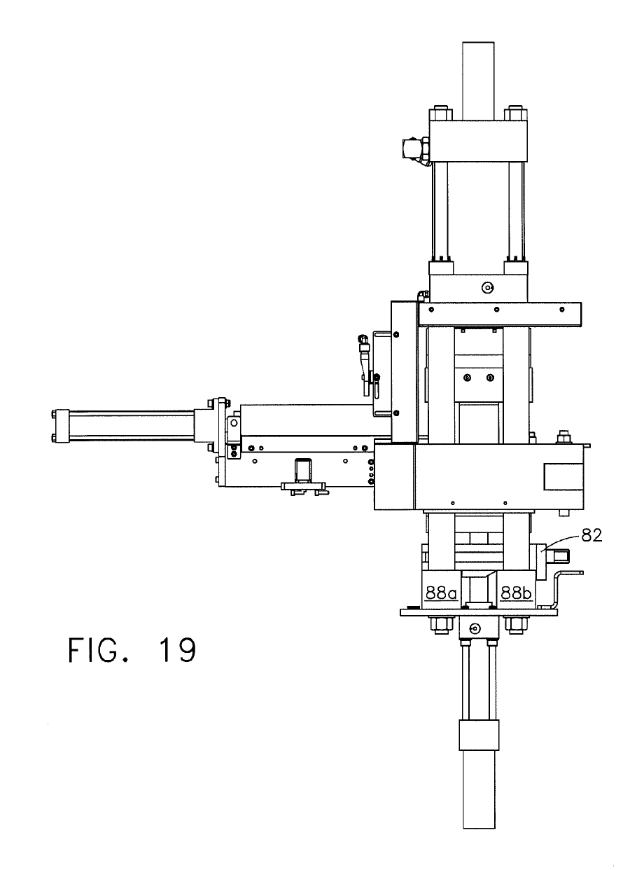

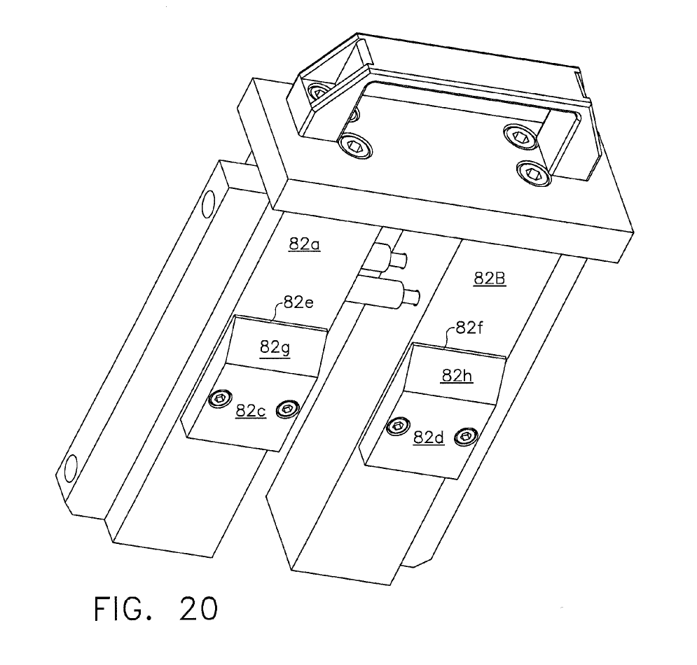

As illustrated by FIG. 16, with eject hydraulic cylinder 80 extended such that eject piston mounting slide 78 is disposed high enough to allow insertion of spacer 82, spacer 82 may be inserted into the space under eject piston mounting slide 78, with the space between spaced apart legs 82a, 82b receiving eject hydraulic cylinder rod 80a, as illustrated in FIG. 17. As it is inserted, spacer 82 is tilted down such that locating pads 82c, 82d (see FIG. 20) align with supports 88a, 88b, such that spacer 82 can be rotated down into its operational position as shown in FIG. 19. The configuration of pads 82c, 82d, including perpendicular lips 82e, 82f at the edge of inclines 82g, 82h, locate spacer 82. Inclines 82g, 82h, help to guide spacer 82 into and out of its operational position.

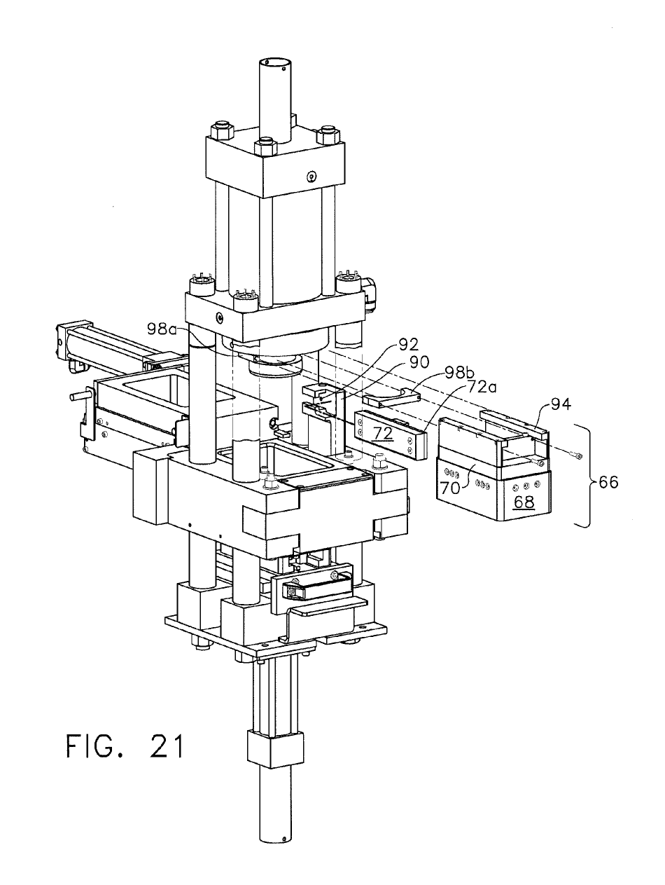

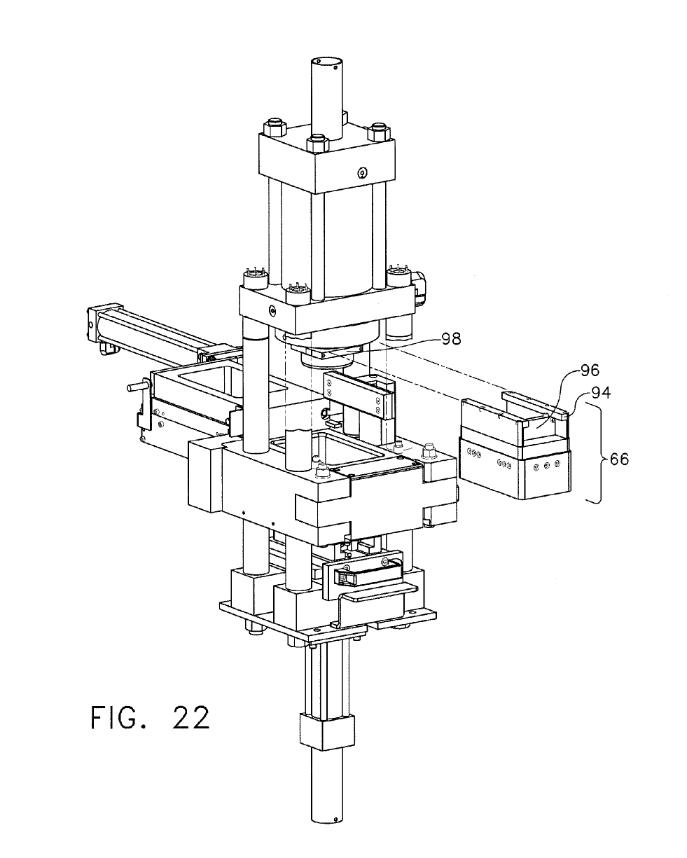

Referring to FIGS. 21 and 22, press piston assembly 66 and press piston guide 72 are shown in a partially exploded view. Press piston guide 72 may be made of any suitable material, such as UHMW. In the depicted embodiment, press piston guide 72 is attached to metallic backing plate 72a, and mounted to leg 90 of forming assembly 26 via a T shaped mount (partially illustrated) or other suitable shape. Guide 72 may be held in place horizontally by detent 92. Press piston block 70 is mounted to press piston mounting slide, which includes mounting plate 96. Attached to the lower end of press hydraulic cylinder rod 64a is two piece mounting collar 98. Press mounting slide 94 includes two spaced apart parallel legs that slidably fit over collar 98, with end plate 96 being secured to collar 98b so as to retain press piston assembly 66 in its proper position.

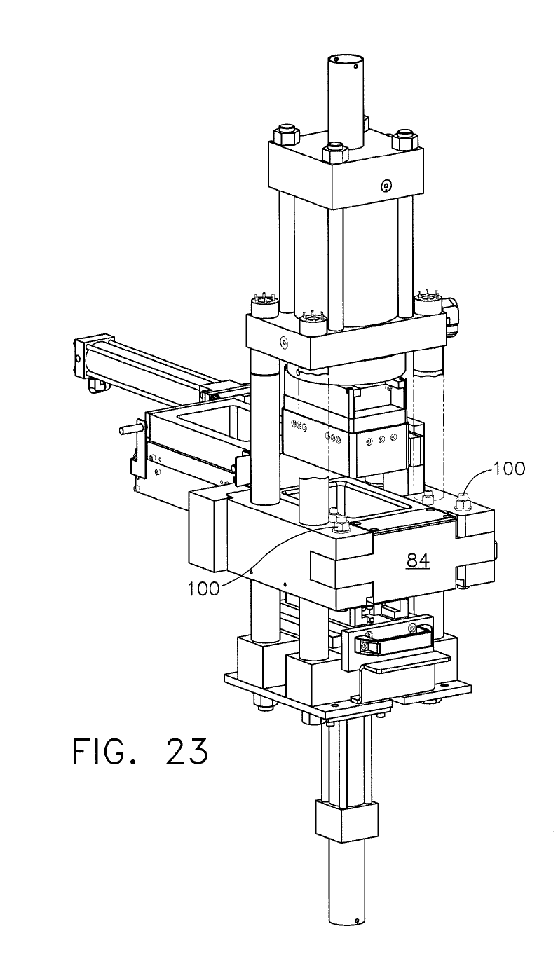

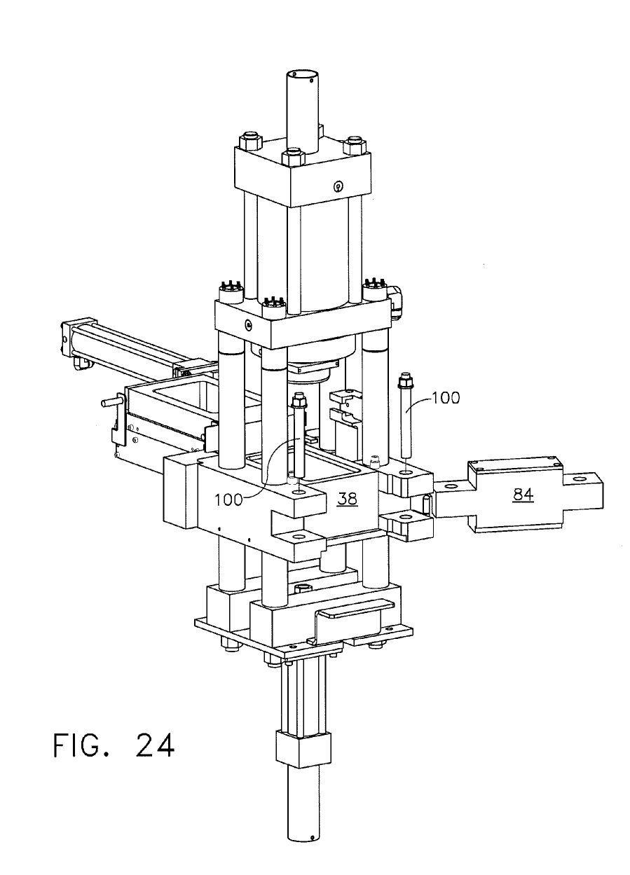

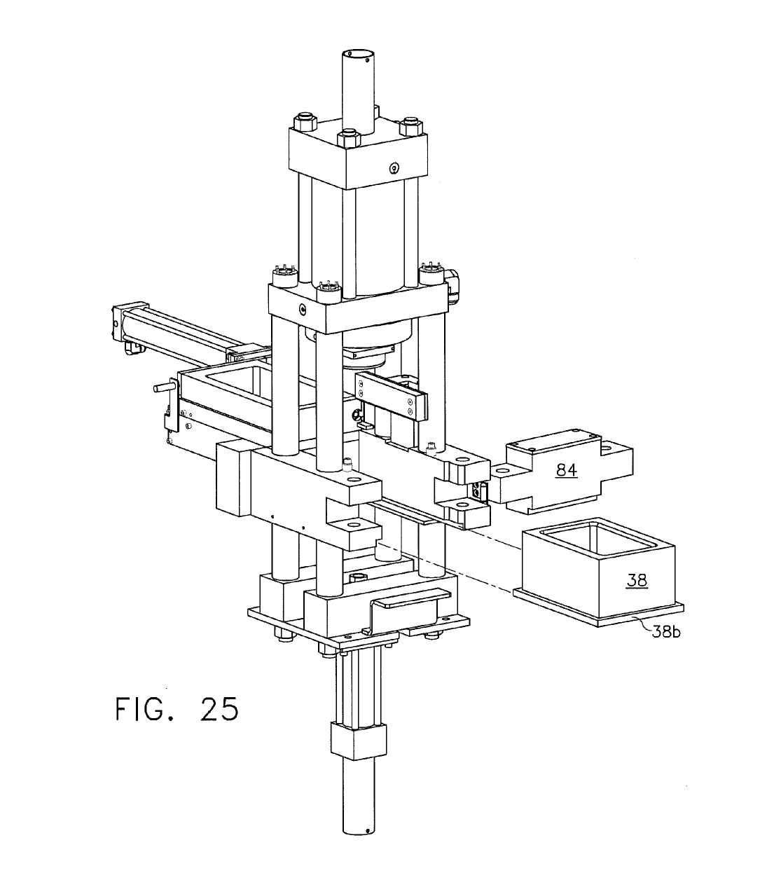

FIGS. 23-25 illustrate the remaining design configuration of forming assembly 26 that permits quick change of forming block 38 and eject piston 74 to accompany the previously described configurations that allow the quick change of press piston assembly 66 press in as little as ten minutes or less to different perimeter dimensions for the formed block. Front block 84 is held in place by tapered pins 100 having hex nuts on their respective upper ends to allow rotation of tapered pins to facilitate removal along their axes by breaking any bond between the pins and the holes. Once removed, front block 84 may be rotated out of the way to allow forming block 38 to be withdrawn horizontally. Not shown in FIGS. 23-25, if eject piston 74 is to be removed, it is removed concomitantly with forming block 38 while disposed in forming chamber 38a. Forming block 38 includes flange 3 8b about its lower edge, which locates forming block within forming assembly 26.

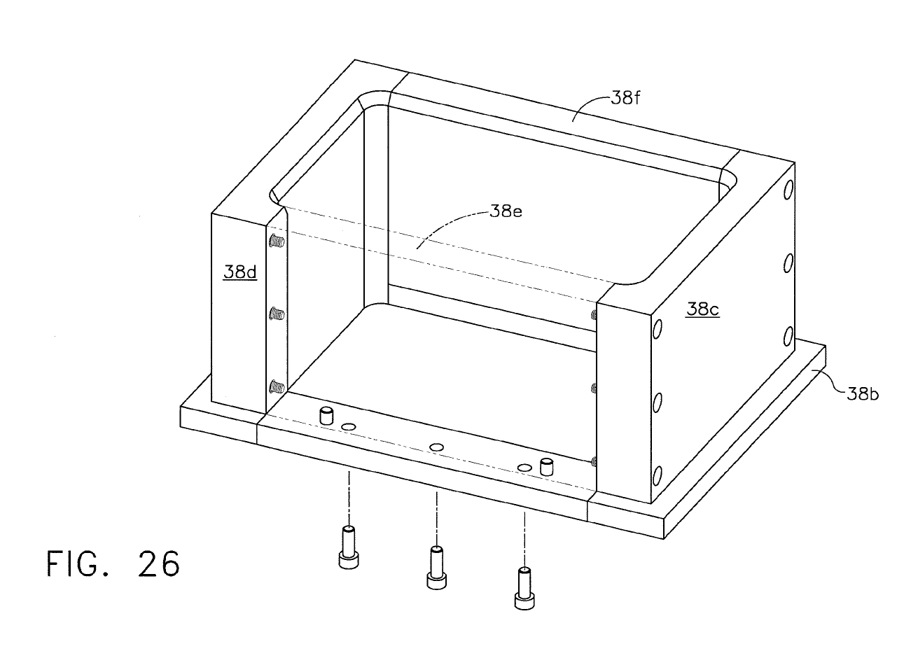

Referring to FIG. 26, forming block 38 may be of any suitable size, shape and material. In the embodiment depicted, forming block 38 comprised end walls 38c, 38d, made of UHMW with side walls 38e and 38f made of stainless steel for dimensional stability and accuracy to avoid temperature gradient induced distortion in the side walls.

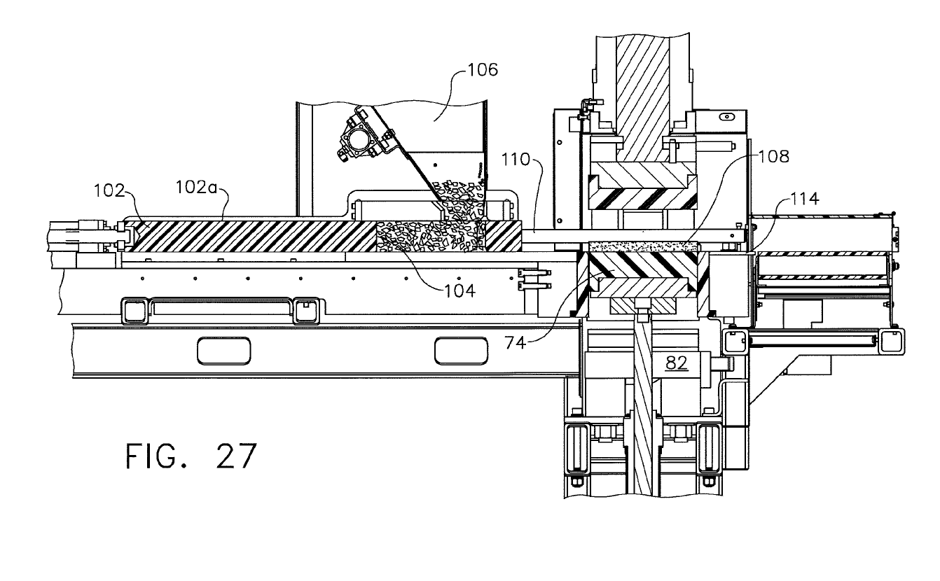

FIGS. 27-31 illustrate the process for forming blocks from carbon dioxide particles utilizing a volumetric embodiment of dosing shuttle, identified in these figures as 102. It will be understood that while the shuttle design and volumetric dosing described with regard to these figures is different from the weight based dosing described earlier, the steps of filling the forming chamber, advancing and retracting the press and eject pistons are applicable to the weight based dosing configuration.

As seen in FIG. 27, volumetric dosing shuttle 102 includes dosing cavity 104.

In the first position, as shown in FIG. 27, dosing cavity 104 directly underlies hopper 106, having no door at the exit of hopper 106, such that particles freely flow into dosing cavity 104. When shuttle 102 is advanced to its second and third positions, upper surface 102a functions as a horizontal door at the exit of hopper 106, blocking a continuous flow of particles. In FIG. 27, eject piston 74 is extended fully up, with a formed block 108 thereon, having a vertical thickness of less than the vertical height of shuttle 102. The exact thickness of block 108 is controlled by the thickness of spacer 82.

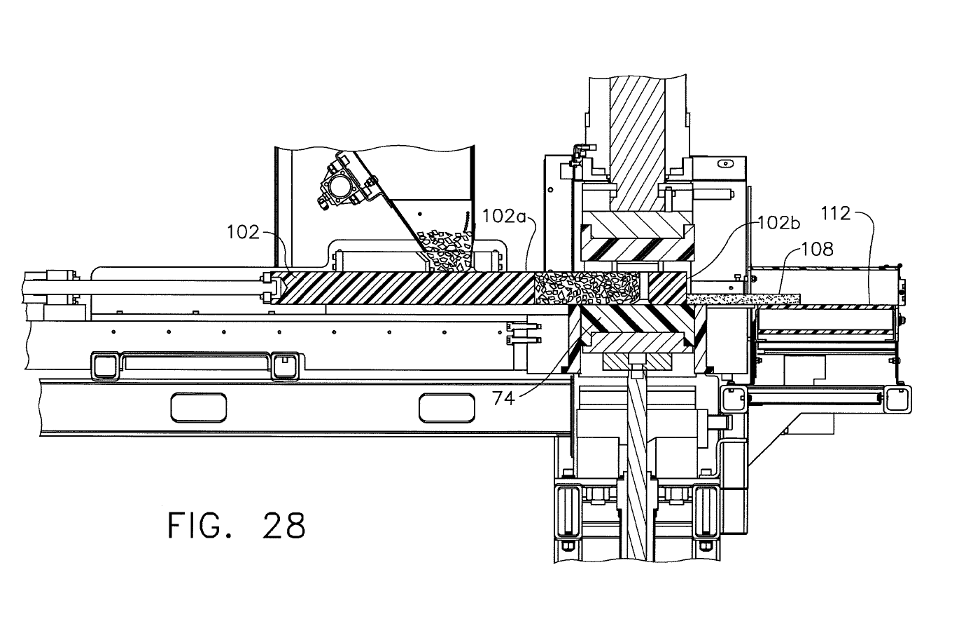

As seen in FIG. 28, shuttle 102 is being advanced from its first position toward the third position, along guide rails 110, to push block 108 onto conveyor belt 112 by the outer distal edge 102b of shuttle 102, passing over UHMW plate 114 (FIG. 29). The exit of hopper 106 is illustrated blocked by upper surface 102a. Eject piston 74 remains at its upper most position, preventing particles from dropping out of cavity 104. FIG. 29 illustrates shuttle 102 in its fully extended, third position.

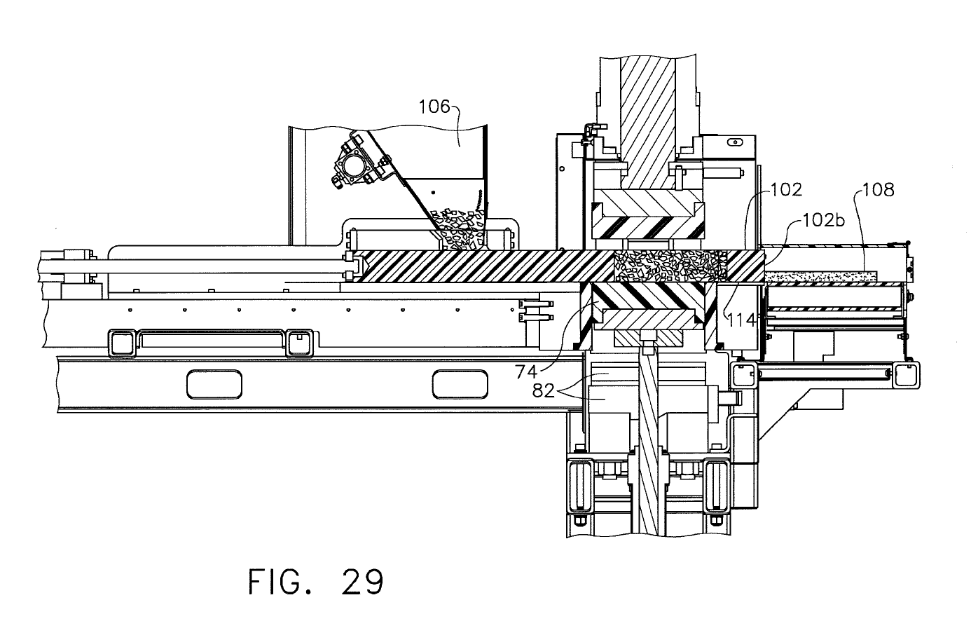

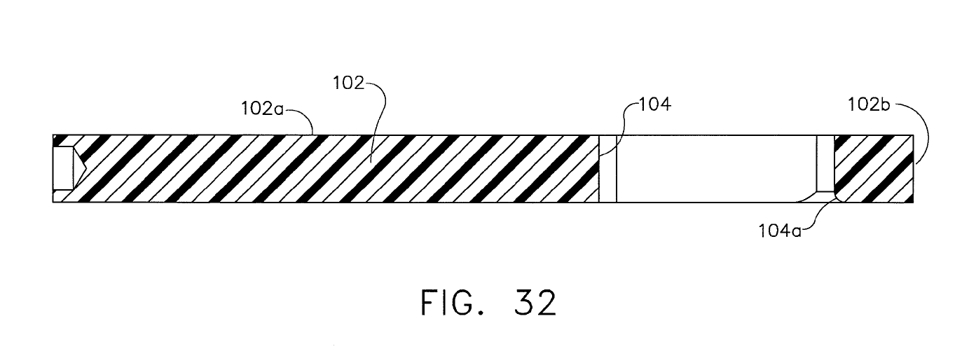

Referring to FIG. 30, eject piston 74 has retracted to its lowest position, adjacent atop spacer 82. Particles are falling into the thusly formed forming chamber, completely filling it, leaving excess particles still disposed within dosing cavity 104 as shuttle 102 retracts to its first position. It is noted that the volume defined by volumetric dosing chamber 104 is larger than the volume of forming chamber as defined by the position of eject piston 74 when adjacent spacer 82. This ensures a complete, and therefore controlled and repeatable dosing and resultant block 108. To reduce the possibility of shuttle 102 wiping particles along with it was it retracts past its second position aligned with the forming chamber, trailing edge 104a of dosing cavity 104 of shuttle 102 is curved to direct pellets into the forming chamber, as shown in FIG. 32.

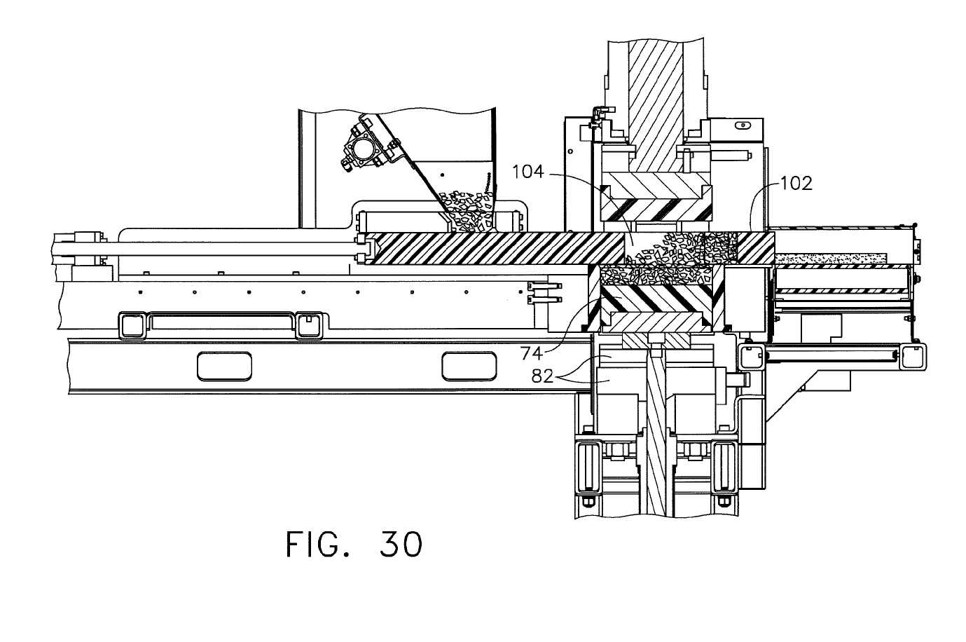

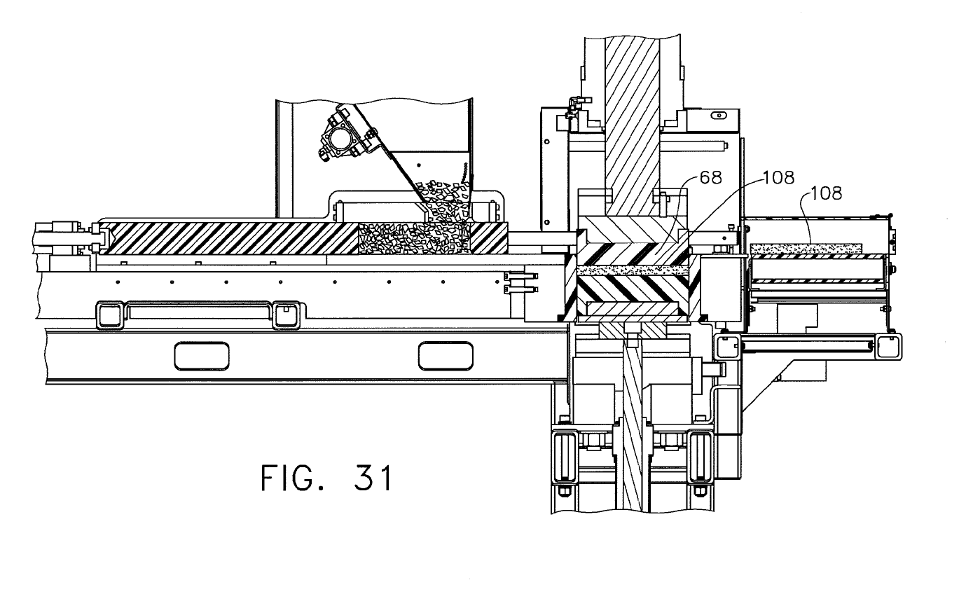

In FIG. 31, press piston 68 has advanced to its full extended position, compressing the particles within the forming chamber to the final block height. Press piston 68 is advanced from its retracted position at its full speed, until the hydraulic pressure of press hydraulic cylinder 64 reaches a predetermined level, at which the speed of press piston 68 is reduced. When the speed of the press piston 68, as monitored by an appropriately placed linear transducer, such as on the hydraulic cylinder rod 64a, drops below a predetermined speed, or the speed profile approaches a predetermined shape, advance of the press piston 68 is stopped, press piston 68 is retracted, and eject piston 74 raised, returning the process to that as shown in FIG. 27, to be repeated cyclically.

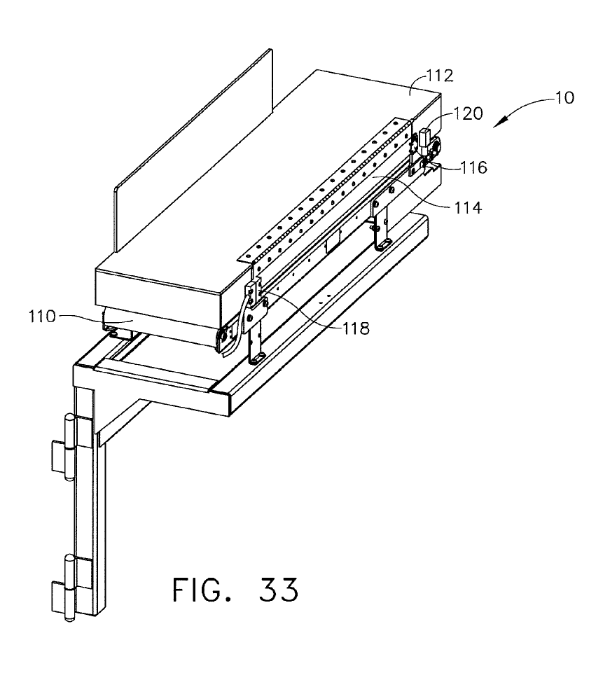

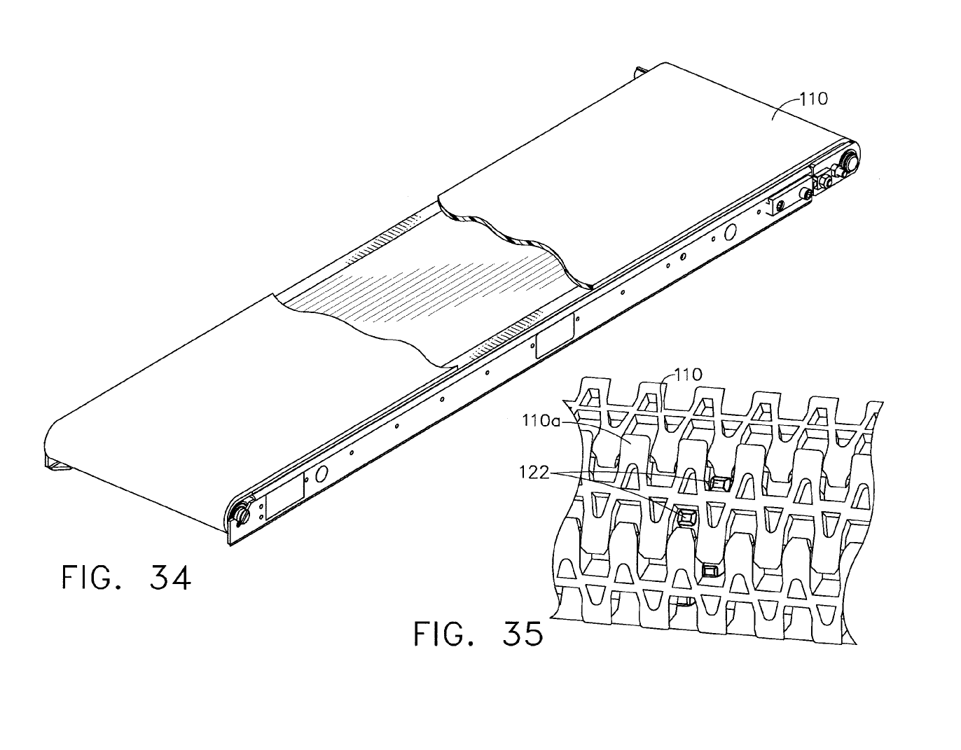

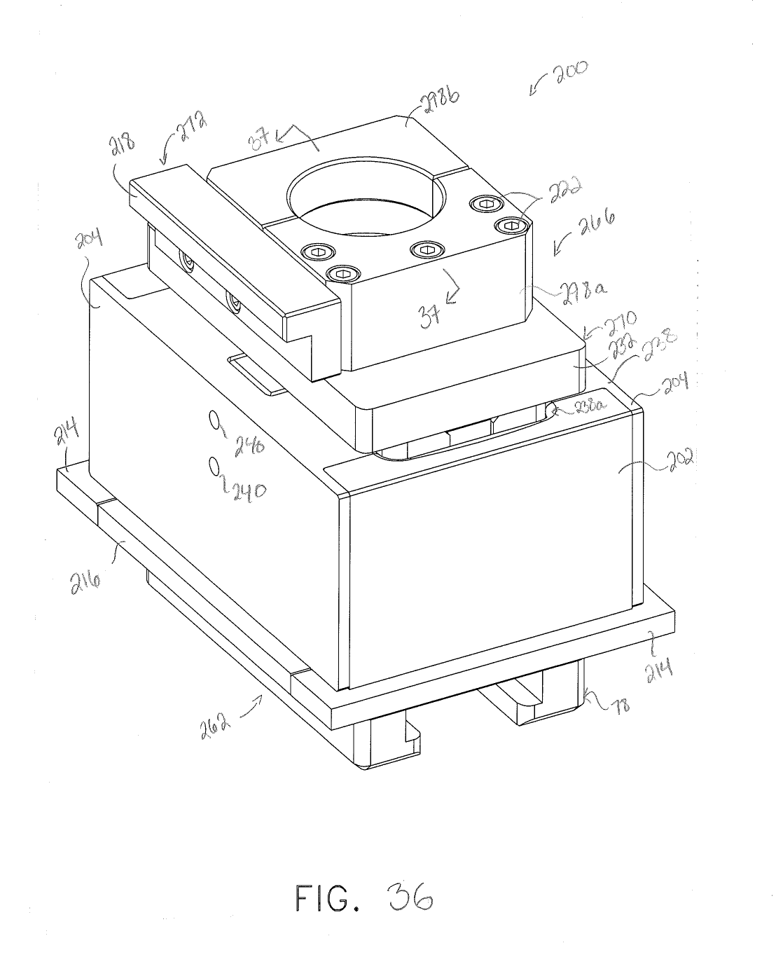

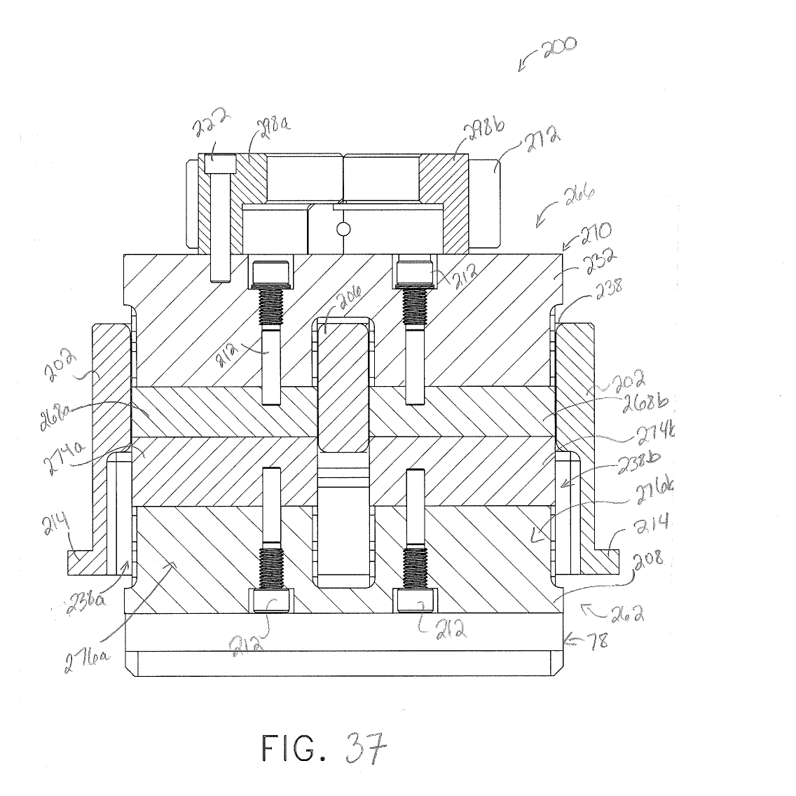

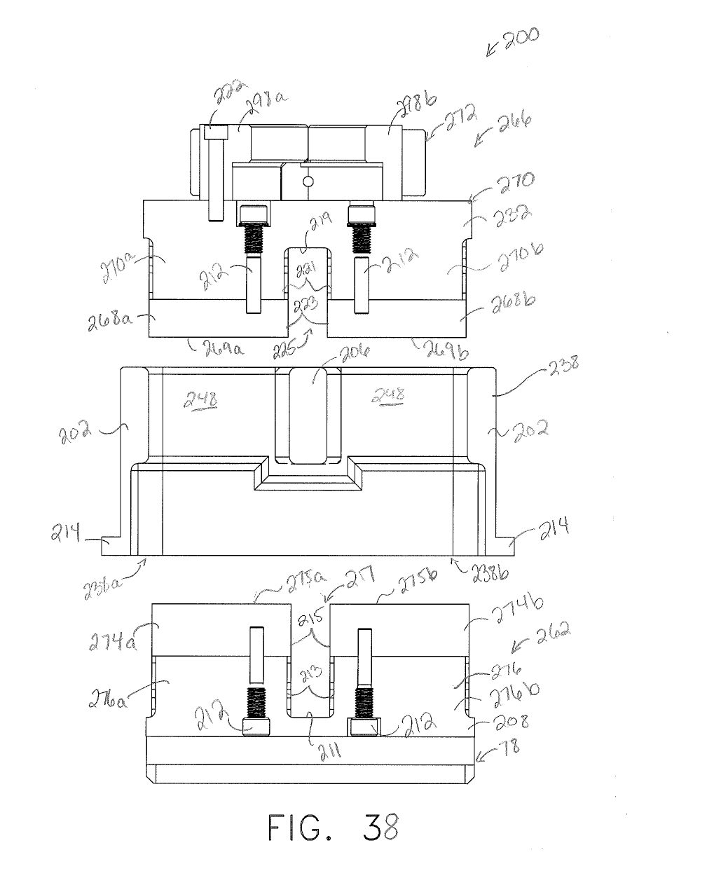

Referring to FIG. 33, conveyor assembly 10 is illustrated. Enclosure 112 overlies conveyor 110, with hinged door 114 along its longitudinal side (relative to discharge direction of conveyor 110). Door 114 is maintained in position by magnetic catch 116. Sensor 118 signals if door 114 is opened, and operation of former 2 is interrupted. This will happen for example if opened by a person during operation, presents a safety hazard. Also, if blocks 108 become jammed on conveyor 110, blocks will push door 114 open, interrupting operation. Adjacent the discharge end of conveyor assembly 10, there is sensor 120. If sensor 120 is blocked longer than a predetermined time, a jam is likely present and the controller interrupts operation.

Referring to FIGS. 34 and 35, conveyor 110 is illustrated supported by a frame. In FIG. 35, a detailed configuration of an embodiment of conveyor 110 is illustrated, showing individual rows 110a of UHMW links driven by sprocket 122.

An alternate embodiment may have a forming block with two chambers and matching two headed press and eject pistons. For example, FIGS. 36-41 show an alternative embodiment capable of simultaneously forming two blocks, as described below. Multiple block formations and different chamber designs are also possible.

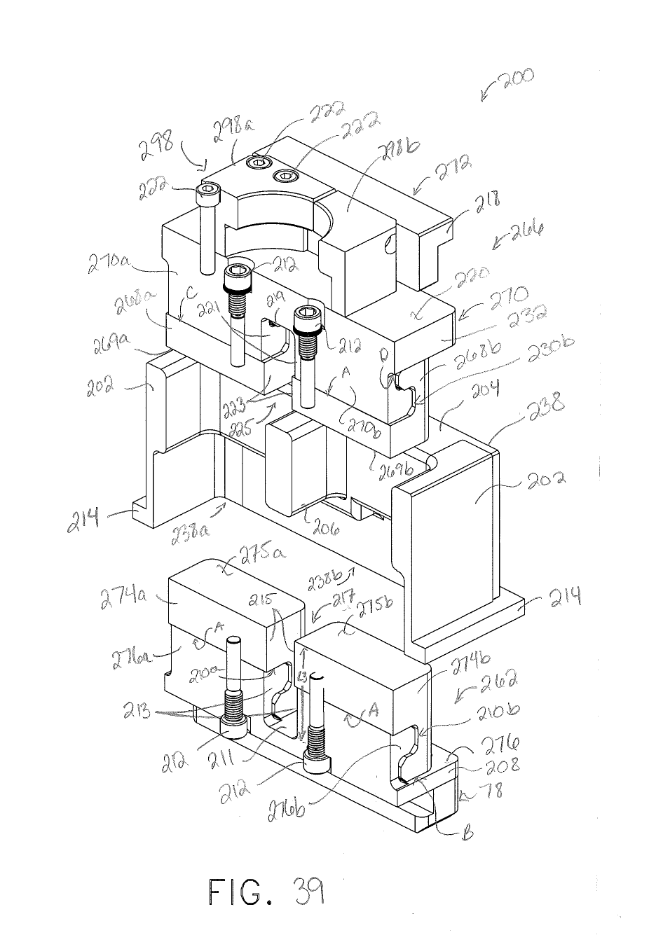

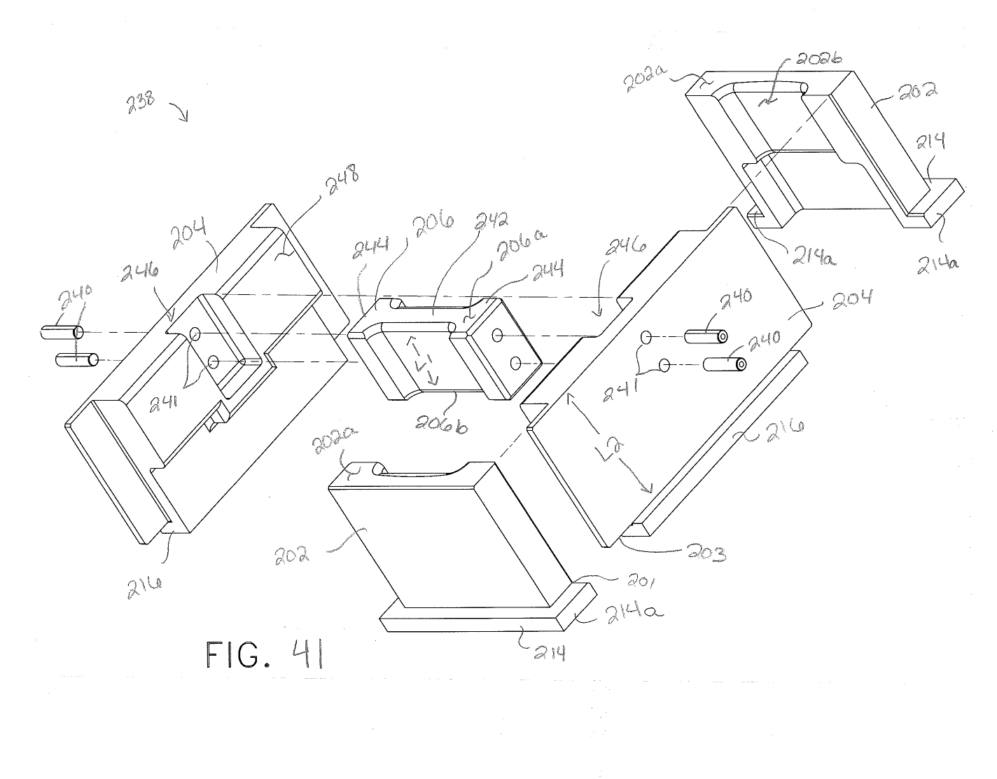

Referring to FIGS. 36-42, a forming chamber block and dual piston assembly 200 includes forming block 238 (FIG. 41), eject piston assembly 262, and press piston assembly 266. As shown in FIG. 39, forming block 238 includes forming chambers 238a, 238b and is defined by five walls—a pair of end walls 202, a pair of side walls 204, and central wall 206. As described below, central wall 206 is fastened to portions of side walls 204. End walls 202 and side walls 204 are attached by protrusions on ends of each end wall 202 being received into correspondingly shaped notches on ends of each side wall 204. The structure of forming block 238 may be held together via the structure of the area of forming assembly 26 into which it is inserted. Alternatively, fasteners may be included to fasten end walls 202 to side walls 204. Flanges 214 laterally extend from bottom portions of front and opposing side faces of end walls 202 and include side portions 214a configured to be disposed under bottom end portions 201 of side walls 204. Flanges 216 laterally extend from intermediate bottom portions 203 of side walls 204 and are disposed between a pair of flanges 214 when forming block 238 is assembled. End walls 202 and flanges 214 are comprised of UHMW or a like material, and side walls 204 and flanges 216 are comprised of stainless steel of, for example, a 303 grade, or of a like material. Flanges 214 and 216 extend outwardly from a lower extent of bottom portions of forming chambers 238a and 238b and cooperate with forming assembly 26 to locate forming block 238 into a proper position.

Central wall 206 is comprised of stainless steel or of UHMW or of a like suitable material and is fastened to center portions of side walls 204 via fasteners such as pins 240 received through apertures 241 formed within side walls 204 and central wall 206. Central wall 206 forms an I-shape with an extended intermediate portion 242 and T-shaped end portions 244 projecting from intermediate portion 242. Each side wall 204 includes recess 246 intermediately disposed in interiorly projecting wall surface 248 and configured to receive one of T-shaped end portions 244. Central wall 206 has length L1 measured between upper surface 206a and lower surface 206b of central wall 206 that is less than length L2 of end walls 202. For example, length L1 may be half the length of length L2. Further, upper surface 206a of central wall 206 is substantially aligned with a plane including upper surfaces 202a of end walls 202 when forming block 238 is assembled. The above described multi-component chamber construction permits tooling to easily slide into and out of the forming block space without removing associated piston assemblies once the piston assemblies have been retracted from forming chambers within the forming block.

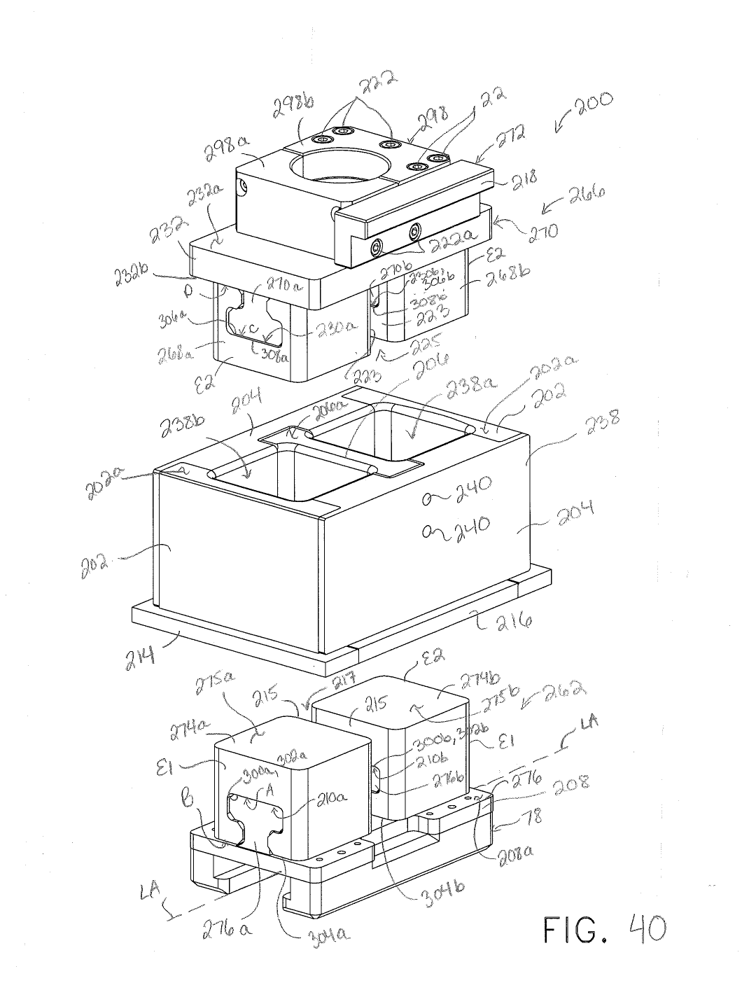

Eject piston assembly 262 includes eject pistons 274a, 274b and eject piston block 276 that is configured to mount to mounting slide 78 in a similar fashion as described above for ejection piston block 76. Eject pistons 274a and 274b each include a T-shaped aperture 210a and 210b (FIG. 40). Each aperture 210a and 210b is defined in an undersurface of respective pistons 274a and 274b and extends from first exterior side wall El to second interior side wall 215 of each respective piston 274a and 274b. Eject pistons 274a and 276b may be made of any suitable material, such as UHMW. Eject piston block 276 may be made of any suitable material such as stainless steel and includes bottom plate portion 208 from which a pair of blocks 276a and 276b upwardly project. Blocks 276a and 276b extend in a direction substantially aligned with longitudinal axis LA of mounting slide 78. Further, blocks 276a and 276b are each shaped and sized for a sliding receipt within T-shaped aperture 210a and 210b. Once blocks 276a and 276b are received within apertures 210a and 210b in, for example, a tongue and groove fashion, eject pistons 274a and 274b are attached to eject piston block 276. Inner wall 211 of bottom plate portion 208 and interior side walls 213 of blocks 276a and 276b along with interior side walls 215 of pistons 274a and 274b define opening 217 sized and shaped to receive a bottom portion of central wall 206 of forming block 238.

Referring to FIGS. 39-40, clearances A between upper surfaces 300a and 300b of blocks 276a and 276b and interior surfaces of upper walls 302a and 302b defining apertures 210a and 210b in pistons 274a and 274b, and may be 0.125″, for example. Clearances B between bottom surfaces 304a and 304b of pistons 274a and 274b and upper surface 208a of bottom plate portion 208 of eject piston block 276 may be, for example, 0.125″. Bottom surfaces 304a and 304b of pistons 274a and 274b may laterally extend away from side edge 208b of bottom plate portion 208 by about, for example, 0.125″. When forming chambers 238a and 238b receive pistons 274a and 274b, exterior side walls E1 of pistons 274a and 274b clear sidewalls forming chambers 238a and 238b by a distance, which may be, for example, 0.10.

A bottom surface of mounting slide 78 is fully supported by either a frame or spacer 82. Fasteners such as bolts or socket-head cap screws 212 (FIG. 39) may be used to further secure eject pistons 274a and 274b to eject piston block 276 by inserting socket-head cap screws 212 vertically through bottom plate portion 208 of eject piston block 276 such that each screw is fastened upwardly through each block 276a and 276b into a respective eject piston 274a and 274b and such that each screw 212 does not extend from an upper surface 275a and 275b of each eject piston 274a and 274b. Each piston 274a and 274b is sized and shaped for receipt within a bottom portion of respective forming chambers 238a, 238b. When pistons 274a and 274b are attached to blocks 276a and 276b, length L3 is defined between upper surface 275a and 275b of each piston 274a and 274b and inner wall 211 that is sufficient to eject a formed block as described above. Thus, when central wall 206 is received in opening 217, length L3 would be greater than length L1 to at least allow lower surface 227 of central wall 206 to be adjacent to inner wall 211 of bottom plate portion 208 such that upper surfaces 275a and 275b are substantially aligned with a plane including upper surfaces of forming block 238 so that dosing shuttle 22 may push a formed block horizontally away from forming block 238 as described above. Further, forming assembly 26 may include a position transducer that permits control of eject piston assembly 262 to determine a distance eject piston assembly 262 travels.

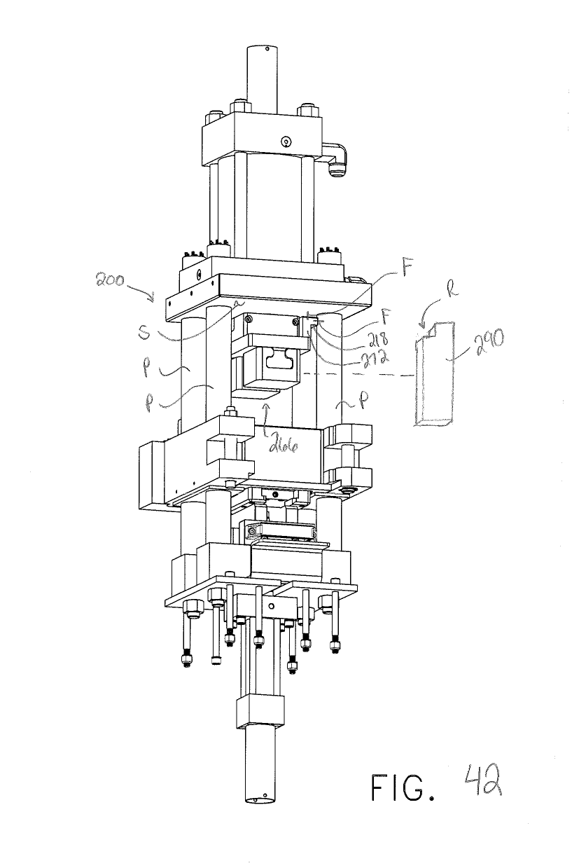

Press piston assembly 266 includes a two piece mounting collar 298, press pistons 268a and 268b, press piston block 270, and a press piston guide 272. Two piece mounting collar 298 is received by a lower end of a press hydraulic cylinder rod (similar to the lower end of press hydraulic cylinder rod 64a described above). Aperture 299 defined by internal walls of two piece mounting collar 298 is substantially concentric with and receives the lower end of the press hydraulic cylinder rod. Press piston guide 272 is attached to pieces 298a and 298b of mounting collar 298 via fasteners such as bolts or socket-head cap screws 222a horizontally oriented to attach mounting collar 298 to press piston guide 272. Press piston guide 272 cooperates with pieces 298a and 298b to position press piston assembly 266 into a properly aligned position with forming block 238, as described below. Press piston guide 272 is mountable to vertically extending leg structure 290 (FIG. 42) of forming assembly 26 similar to leg 90 (FIG. 21) described above via a fastening mechanism such as, for example, one or more fasteners F and/or receipt of rail 218 of press piston guide 272 into recess R of the vertically extending leg structure 290 of forming assembly 26. The recess of the vertically extending leg structure would be sized and shaped to receive rail 218. Additionally or alternatively, as shown in FIG. 42, rail 218 is fastened to bottom wall surface S from which rod 64a downwardly projects and/or to a pair of posts P downwardly projecting from bottom wall surface S from which rod 64a downwardly projects. Additionally or alternatively, rail 218 is received in recesses defined in the pair of posts P. Mounting collar 298 is fastened to an upper surface 220 of press piston block 270 via one or more fasteners such as socket-head cap screws 222. Press piston guide 272 is attached to side of mounting collar 298 such that press piston guide 272 may be received in recess R of the vertically extending leg structure and the recess includes a longitudinal axis that is substantially aligned and parallel to a longitudinal axis of mounting collar 298.

Press pistons 268a and 268b each include T-shaped apertures 230a and 230b. Each of apertures 230a and 230b is defined in an upper surface of respective pistons 268a and 268b and extend from first exterior side wall E2 to second interior side wall 223 of each respective piston 268a and 268b. Press pistons 268a and 268b may be made of any suitable material, such as UHMW. Press piston block 270 may be made of any suitable material such as stainless steel and includes upper plate portion 232 from which a pair of blocks 270a and 270b downwardly project. Further, blocks 270a and 270b are each shaped and sized for a sliding receipt within a respective T-shaped aperture 230a and 230b. Inner wall 219 of upper plate portion 232 and interior side walls 221 of blocks 270a and 270b along with interior side walls 223 of pistons 268a and 268b define an opening 225 sized and shaped to receive an upper portion of central wall 206.

Clearances C between bottom surfaces 306a and 306b of blocks 270a and 270b and interior surfaces of lower walls 308a and 308b defining apertures 230a and 230b in pistons 268a and 268b, and may be 0.125″, for example. Clearance D between upper surfaces 310a and 310b of pistons 268a and 268b and bottom surface 232b of upper plate portion 232 of press piston block 270 (bottom surface 232b opposed from upper surface 232a of upper plate portion 232) may be, for example, 0.125″. Bottom surfaces 304a and 304b of pistons 274a and 274b may laterally extend away from side edge 208b of bottom plate portion 208 by about, for example, 0.125″. Once blocks 270a and 270b are received within apertures 230a and 230b in, for example, a tongue and groove fashion, press pistons 268a and 268b are attached to press piston block 270. Fasteners such as socket-head cap screws 212 may be used to further secure press pistons 268a and 268b to press piston block 270 by inserting socket-head cap screws 212 vertically through upper plate portion 232 of press piston block 270 such that each screw is fastened downwardly through each block 270a and 270b into a respective press piston 268a and 268b and such that each screw 212 does not extend from bottom surface 269a and 269b of each press piston 268a and 268b. Each block 270a and 270b is sized and shaped for receipt within an upper portion of respective forming chambers 238a, 238b.

The alternative embodiment of forming chamber block and dual piston assembly 200 described above and shown in FIGS. 36-42 is operable with dosing assembly as described above for piston assembly 60 and eject assembly 62, with the understanding that press piston assembly 66 of piston assembly 60 is replaced by press piston assembly 266 and eject assembly 62 is replaced by eject assembly 262, and that there is a modified mating interface between press piston assembly 266 and vertically extending leg structure 290 (FIG. 42) of forming assembly 26 that replaces leg 90 described above. Other interfaces of forming assembly 26 may be modified as apparent to one of ordinary skill in the art for forming chamber block and dual piston assembly 200 to be received within forming assembly 26. Otherwise, hydraulic cylinders 64 and 80 cooperate with respective press piston assembly 266 and eject assembly 262 as described above with respect to press piston assembly 66 and eject assembly 62.

Dosing shuttle 22 (FIGS. 6 and 7) is reciprocated as described earlier from a first position at which dosing cavity 24 is aligned with opening 20a so that dosing cavity 24 can be charged with particles, and a second position at which dosing cavity 24 is now aligned with forming chambers 238a and 238b so that forming chambers 238a and 238b can be charged with particles discharged from dosing cavity 24, and a third position at which dosing shuttle 22 has pushed two formed blocks onto the conveyor. Sensor 36 is positioned to sense when dosing shuttle 22 is in the charging position, and another sensor (not seen in FIG. 6) senses when dosing cavity 24 is aligned with forming chambers 238a and 238b.

Press hydraulic cylinder 64 cooperates with press piston assembly 266 in a manner similar to that described above with respect to the cooperation of hydraulic cylinder 64 and press piston assembly 66. Eject piston block 276 of eject piston assembly 262 is mounted to eject piston mounting slide 78, which is releasably connected to eject hydraulic cylinder 80. Spacer 82 is disposed beneath eject piston mounting slide 78, supported vertically on its lower side, establishing the position of the upper surfaces 275a and 275b of respective eject pistons 274a and 274b within respective forming chambers 238a and 238b. During formation of blocks, spacer 82 functions as the reaction member to the force exerted by press pistons 268a and 268b, through the carbon dioxide particles, through eject pistons 274a and 274b, and through eject piston block 276. With this construction, lower eject hydraulic cylinder 80 is not disposed to oppose the force of press hydraulic cylinder 64, but only disposed and configured to lift eject pistons 274a and 274b to eject a pair of formed blocks. Additionally, pressure relief valves may be utilized to prevent hydraulic cylinder 64 of press piston assembly 266 when in an extended position from overpowering hydraulic cylinder 80 of ejection piston assembly 262, which overpowering may cause excessive line pressure on the pair of formed blocks. When hydraulic cylinder 64 is in a retracted position, spacer 82 provides such a reaction.

As described above with respect to the removal of eject piston 74 while within forming chamber 38a, if eject piston assembly 262 is to be removed, it is removed concomitantly with forming block 238 while pistons 274a and 274b are fully disposed in forming chambers 338a and 338b and once front block 84 is rotated out of the way. To install eject piston assembly 262 and forming block 238, eject piston assembly 262 may be installed separately from forming block 238 (such as when spacer 82 has not been inserted) or together with forming block 238 as a unit (where pistons 274a and 274b are fully disposed in forming chambers 338a and 338b) inserted through the passage opened when front block 84 is rotated out of the way.

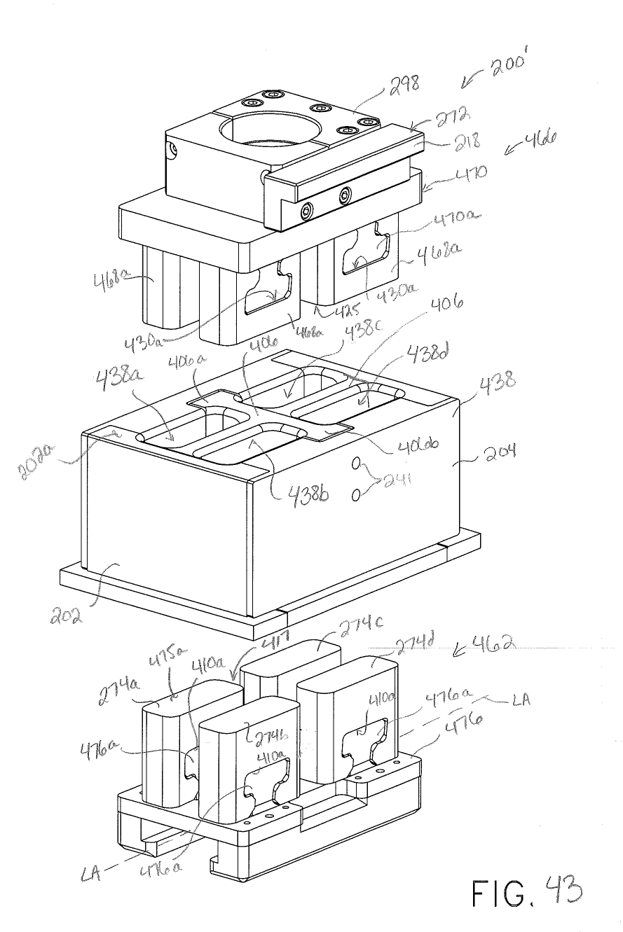

Forming chambers 238a and 238b may be replaced by alternative embodiments include a multiple or plurality of chambers that align with a respective plurality of eject and press pistons in a manner similar to the process described above. For example, as shown in FIG. 43, forming block 438 includes forming chambers 438a, 438b, 438c, and 438d. Forming block 438 is similar to forming block 238, including similar components expect as otherwise indicated below. For example, mounting collar 298 is shown in both FIG. 36 and for an alternative embodiment of forming chamber block and dual piston assembly 200; in FIG. 43. Central wall 206, for example, is replaced with a cross-shaped partitioning wall 406. Cross-shaped portioning wall 406 is a single-piece, solid, monolithic unit that mechanically locks to walls 202 and 206 and that made of any suitable material such as stainless steel. Ends 406a and 406b are received into recesses 246 of side walls 204 as described above for central wall 206. Ends 406c and 406d, disposed substantially perpendicular to ends 406a and 406b, are disposed adjacent interior portions 202b (FIG. 41) of end walls 202 and may be disposed in recesses defined in end walls 202 that are similar to recesses 246 and may be fastened to the recesses in the same manner central wall 206 is fastened to side walls 204.

Eject piston assembly 462 includes eject pistons 474a, and eject piston block 476, which is similar to eject piston block 276 described above except for the differences described below. Eject pistons 474a (each similar to the other and depicted by the same reference numeral herein) each include a T-shaped aperture 410a. Four blocks 476a (each similar to the other and depicted by the same reference numeral herein) upwardly project from bottom plate portion 408 of eject piston block 476. Blocks 476a extend in a direction substantially perpendicular to the longitudinal axis LA of mounting slide 78. Blocks 476a are each shaped and sized for a sliding receipt within T-shaped apertures 410a. Pistons 474a are attached to eject piston block 476 in a manner similar to that described above for the attachment of pistons 274a to eject piston block 276.

When attached to eject piston block 476, pistons 474a form a cross-shaped opening 417 sized and shaped to receive cross-shaped partitioning wall 406 and cooperate with cross-shaped partitioning wall 406 similar to the fashion in which opening 217 cooperates with central wall 206 such that upper surfaces 475a of pistons 474a are able to be substantially aligned with upper surfaces 202a of end walls 202 so that formed blocks may be ejected by dosing shuttle 22 as described above. Pistons 474a are sized and shaped for receipt within forming chambers 438a-438d.

Press piston assembly 466 includes a two piece mounting collar 298, press pistons 468a and 468b, press piston block 470, and a press piston guide 272. Pistons 468a of press piston assembly 466 cooperate with press piston block 470 in a manner similar to the cooperation of pistons 476a with eject piston block 476, except that blocks 470a that are sized and shaped to receive T-shaped apertures 430a of pistons 468a extend downwardly from press piston block 470. When attached to press piston block 470, pistons 468a form a cross-shaped opening 425 sized and shaped to receive cross-shaped partitioning wall 406. Pistons 468a are sized and shaped for receipt within forming chambers 438a-438d.

The foregoing description of an embodiment of the invention has been presented for purposes of illustration and description. It is not intended to be exhaustive or to limit the invention to the precise form disclosed. Obvious modifications or variations are possible in light of the above teachings. The embodiment was chosen and described in order to best illustrate the principles of the invention and its practical application to thereby enable one of ordinary skill in the art to best utilize the invention in various embodiments and with various modifications as are suited to the particular use contemplated. Although only a limited number of embodiments of the invention is explained in detail, it is to be understood that the invention is not limited in its scope to the details of construction and arrangement of components set forth in the preceding description or illustrated in the drawings. The invention is capable of other embodiments and of being practiced or carried out in various ways. Also, in describing the preferred embodiment, specific terminology was used for the sake of clarity. It is to be understood that each specific term includes all technical equivalents which operate in a similar manner to accomplish a similar purpose. It is intended that the scope of the invention be defined by the claims submitted herewith.

1. An apparatus for compressing discrete particles of solid carbon dioxide into a plurality of blocks comprising:
a. a dosing chamber configured to receive and discharge said particles, said dosing chamber defining a dosing volume, said dosing chamber being moveable from a first position at which said particles are received to a second position, wherein as said dosing chamber moves to said second position particles disposed within said dosing chamber are discharged;
b. a forming block comprising a pair of forming chambers configured to receive said particles from said dosing chamber when said dosing chamber is moved to said second position, each said forming chamber at least partially defining a respective forming chamber volume, each forming chamber volume being capable of being varied from an initial forming chamber volume to a reduced forming chamber volume; and
c. said dosing volume being larger than a sum of said initial forming chamber volumes.

2. The apparatus of claim 1, comprising a moveable member configured to vary each forming chamber volume from each initial forming chamber volume to each reduced forming chamber thereby compressing particles disposed within each forming chamber into a block.

3. The apparatus of claim 1, comprising a moveable member configured to eject a block from each forming chamber.

4. The apparatus of claim 1, wherein said dosing chamber includes an opening through which said particles are discharged into each forming chamber when said dosing chamber moves to said second position, said opening including a curved edge.

5. The apparatus of claim 4, wherein said curved edge is a trailing edge.

6. The apparatus of claim 1, comprising a hopper configured to charge said particles into said dosing chamber when said dosing chamber is disposed at said first position.

7. The apparatus of claim 6, wherein said dosing chamber is completely filled when said dosing chamber is disposed at said first position.

8. A method of forming discrete particles of solid carbon dioxide into a plurality of blocks, said method comprising the steps of:
a. providing a plurality of forming chambers configured to receive said particles through an opening, each forming chamber at least partially defining a forming chamber volume, each forming chamber volume being capable of being varied from an initial forming chamber volume to a reduced forming chamber volume;
b. dispensing a first portion of a volume of said particles into each forming chamber and disposing a second portion of said volume of particles adjacent said opening contiguous to said first portion, said volume of particles being greater than a sum of the initial forming chamber volumes;
c. wiping said second portion away from said opening; and
d. compressing said particles disposed within each forming chamber into a block.

9. The method of claim 8, wherein the step of dispensing and disposing comprises the steps of:
a. dispensing said volume of particles into a dosing chamber;
b. moving said dosing chamber into a position at which said first portion of said volume of particles is dispensed into each forming chamber and said second portion of said volume of particles is disposed adjacent said opening.

10. The method of claim 8, wherein the step of dispensing and disposing comprises the steps of:
a. disposing a dosing chamber at a first position;
b. dispensing said volume of particles into said dosing chamber;
c. moving said dosing chamber into a second position at which said first portion of said volume of particles is dispensed into each forming chamber and said second portion of said volume of particles is disposed adjacent said opening.

11. An apparatus for compressing discrete particles of solid carbon dioxide into a pair of blocks comprising:
a. a press assembly comprising a pair of press pistons, a first hydraulic cylinder, and a pair of press piston blocks, wherein the pair of press pistons are removably securable to the pair of press piston blocks to from a press piston assembly, wherein the press piston assembly is configured to be driven by the first hydraulic cylinder;
b. an eject assembly comprising a pair of eject pistons, a second hydraulic cylinder, and a pair of eject piston blocks, wherein the pair of eject pistons are removably securable to the pair of eject piston blocks to from an eject piston assembly, wherein the eject piston assembly is configured to be driven by the first hydraulic cylinder;
c. a forming block comprising a central wall and a pair of forming chambers divided by the central wall, wherein the pair of forming chambers are configured to receive the press pistons at an upper end and the eject pistons at a lower end;
wherein the eject pistons each include a length sufficient to eject an upper surface of each eject piston to a plane level with an upper surface of the forming block.

12. The apparatus of claim 11, comprising:
a. a dosing chamber configured to receive and discharge said particles, said dosing chamber defining a dosing volume, said dosing chamber being moveable from a first position at which said particles are received to a second position, wherein as said dosing chamber moves to said second position particles disposed within said dosing chamber are discharged; and
wherein each forming chamber is configured to receive said particles from said dosing chamber when said dosing chamber is moved to said second position, each forming chamber at least partially defining a forming chamber volume, each forming chamber volume being capable of being varied from an initial forming chamber volume to a reduced forming chamber volume; and
wherein said dosing volume is larger than each initial forming chamber volume.

13. The apparatus of claim 11, wherein each press piston block includes a T-shaped protrusion, wherein each press piston includes a T-shaped aperture configured to receive the T-shaped protrusion.

14. The apparatus of claim 13, further comprising a vertically oriented fastener configured to secure each protrusion of each press piston block to each press piston, wherein at least one end of each fastener is disposed a distance beneath a first surface of each press piston.

15. The apparatus of claim 11, wherein each eject piston block includes a T-shaped protrusion, wherein each eject piston includes a T-shaped aperture configured to receive the T-shaped protrusion.

16. The apparatus of claim 15, further comprising a vertically oriented fastener configured to secure each protrusion of each eject piston block to each eject piston, wherein at least one end of each fastener is disposed a distance beneath a first surface of each eject piston.

17. The apparatus of claim 11, wherein the central wall is disposed between a pair of outer walls defining the chambers, wherein each outer wall comprises an outer wall length, and wherein ends of the central wall are pinned to portions of said outer walls.

18. The apparatus of claim 17, wherein the central wall includes a length that is less than the outer wall length.

19. The apparatus of claim 18, wherein the length of the central wall is equal to or less than half the outer wall length.

20. The apparatus of claim 19, wherein an upper surface of the central wall is substantially aligned with an upper surface of each outer wall.
